(19) United States
(12) Patent Application Publication
(10) Pub. No.: US 2024/0381215 A1
(43) Pub. Date: Nov. 14, 2024

(54) CONDITIONAL HANDOVERS BASED ON A NETWORK ENERGY SAVING MODE

(71) Applicant: QUALCOMM Incorporated, San Diego, CA (US)

(72) Inventors: Sherif ELAZZOUNI, San Diego, CA (US); Navid ABEDINI, Basking Ridge, NJ (US); Naeem AKL, Bridgewater, NJ (US); Ozcan OZTURK, San Diego, CA (US); Shankar KRISHNAN, Poway, CA (US)

(21) Appl. No.: 18/647,195

(22) Filed: Apr. 26, 2024

Related U.S. Application Data
(60) Provisional application No. 63/501,121, filed on May 9, 2023.

(51) Int. Cl. H04W 36/36; H04W 52/02

(52) U.S. Cl. CPC H04W 36/362; H04W 52/0209

(57) ABSTRACT

Various aspects of the present disclosure generally relate to wireless communication. In some aspects, a user equipment (UE) may receive an indication of a network energy saving (NES) conditional handover threshold. The UE may monitor one or more received signals based at least in part on the NES conditional handover threshold. Numerous other aspects are described.

### CROSS-REFERENCE TO RELATED APPLICATION

This patent application claims priority to U.S. Provisional Patent Application No. 63/501,121, filed May 9, 2023, entitled “CONDITIONAL HANDOVERS BASED ON A NETWORK ENERGY SAVING MODE,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for conditional handovers based on a network energy saving mode.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a network energy saving (NES) conditional handover condition (e.g., an NES conditional handover threshold). The method may include monitoring one or more received signals based at least in part on the NES conditional handover threshold.

Some aspects described herein relate to a method of wireless communication performed by a network node. The method may include transmitting an indication of an NES conditional handover condition (e.g., an NES conditional handover threshold).

Some aspects described herein relate to an apparatus for wireless communication at a UE. The apparatus may include one or more memories and one or more processors coupled to the one or more memories. The one or more processors may be configured to cause the apparatus to receive an indication of an NES conditional handover condition (e.g., an NES conditional handover threshold). The one or more processors may be configured to cause the apparatus to monitor one or more received signals based at least in part on the NES conditional handover threshold.

Some aspects described herein relate to an apparatus for wireless communication at a network node. The apparatus may include one or more memories and one or more processors coupled to the one or more memories. The one or more processors may be configured to cause the apparatus to transmit an indication of an NES conditional handover condition (e.g., an NES conditional handover threshold).

Some aspects described herein relate to a non-transitory computer-readable medium that stores a set of instructions for wireless communication by a UE. The set of instructions, when executed by one or more processors of the UE, may cause the UE to receive an indication of an NES conditional handover condition (e.g., an NES conditional handover threshold). The set of instructions, when executed by one or more processors of the UE, may cause the UE to monitor one or more received signals based at least in part on the NES conditional handover threshold.

Some aspects described herein relate to a non-transitory computer-readable medium that stores a set of instructions for wireless communication by a network node. The set of instructions, when executed by one or more processors of the network node, may cause the network node to transmit an indication of an NES conditional handover condition (e.g., an NES conditional handover threshold).

Some aspects described herein relate to an apparatus for wireless communication. The apparatus may include means for receiving an indication of an NES conditional handover threshold. The apparatus may include means for monitoring one or more received signals based at least in part on the NES conditional handover condition (e.g., an NES conditional handover threshold).

Some aspects described herein relate to an apparatus for wireless communication. The apparatus may include means for transmitting an indication of an NES conditional handover condition (e.g., an NES conditional handover threshold).

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of make-before-break handover, in accordance with the present disclosure.

FIG. 5 is a diagram illustrating an example of a wireless communication process between a source network node, a UE, and a target network node, in accordance with the present disclosure.

FIG. 6 is a diagram illustrating an example of a wireless communication process between the source network node, the UE, and the target network node as described with regard to FIG. 5, and a second target network node, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

A network node transitioning into a network energy saving (NES) mode may introduce one or more inefficiencies in a handover procedure. To illustrate, as part of transitioning to the NES mode, a source network node may offload an attached user equipment (UE) and/or multiple UEs to other network nodes. To offload the UEs, the network node may transmit a respective radio resource control (RRC) reconfiguration message to each UE that instructs the UE to perform a handover. The transmission of multiple RRC reconfiguration messages may delay a source network node from transitioning into the NES mode, delay the UE performing the handover, increase an energy consumption by the source network node, increase energy consumption at the UE, and/or reduce a battery life at the UE as described below.

Alternatively, or additionally, a target network node may notify the source network node that the target network node is transitioning to the NES mode, and the source network node may change one or more conditional handover conditions that are associated with the target network node to mitigate a UE triggering a conditional handover to the target network node. However, in a similar manner as described above, the source network node transmit a respective RRC reconfiguration message to each UE that indicates an update to one or more conditional handover conditions associated with the target network node. The transmission of multiple RRC reconfiguration messages may delay the UE performing the handover, increase energy consumption at the UE, and/or reduce a battery life at the UE as described below.

Various aspects described herein generally relate to conditional handovers based on an NES mode. Some aspects more specifically relate to reducing signaling overhead for conditional handovers that are based at least in part on an NES mode. In some aspects, a UE may receive an indication of an NES conditional handover condition, such as an NES conditional handover threshold. As described below, the NES conditional handover may differ from a baseline conditional handover threshold and/or a current conditional handover at the UE. Based at least in part on receiving the indication of the NES conditional handover threshold, the UE may monitor and/or evaluate one or more received signals based at least in part on the NES conditional handover threshold. As one example, the UE may detect a conditional handover trigger event based at least in part on the NES conditional handover threshold and/or the UE may perform a conditional handover to a target network node. As another example, the UE may not detect the occurrence of the conditional handover trigger event (e.g., that is based at least in part on the NES conditional handover threshold), and, subsequently, may refrain from performing the conditional handover to the target network node.

In some aspects, a network node may transmit an indication of an NES conditional handover condition, such as an NES conditional handover threshold. As one example, the network node may transmit the indication of the NES conditional handover using a different mechanism than RRC signaling, such as by transmitting the indication of the NES conditional handover in Layer 1 (L1) signaling and/or Layer 2 (L2) signaling. In some aspects, the indication of an NES conditional handover threshold may be an indication to change a threshold that is used for an existing conditional handover configuration and/or an existing conditional handover condition. That is, the NES conditional handover threshold may indicate a change (e.g., an offset) to apply to a current conditional handover threshold.

The use of an NES conditional handover condition (e.g., an NES conditional handover threshold) may enable a source network node to offload attached UEs and/or provide updated conditional handover thresholds (e.g., associated with a target network node) using a different mechanism than RRC signaling (e.g., an RRC reconfiguration message). Accordingly, the source network node may offload attached UEs and/or mitigate the UEs performing a handover to a target network node that is operating in an NES mode based at least in part on using a reduced number of RRC messages and/or reduced RRC signaling. Reduced RRC signaling may enable the source network node to reduce energy consumption and/or transition to an NES mode more quickly. As one example of reduced energy consumption, the source network node may reduce a coverage area provided by the source network node more quickly. In some aspects, reducing RRC signaling may mitigate each UE replying with complementary RRC signaling (e.g., an RRC reconfiguration complete message), reduce energy consumption by the UE, and preserve a battery life of the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

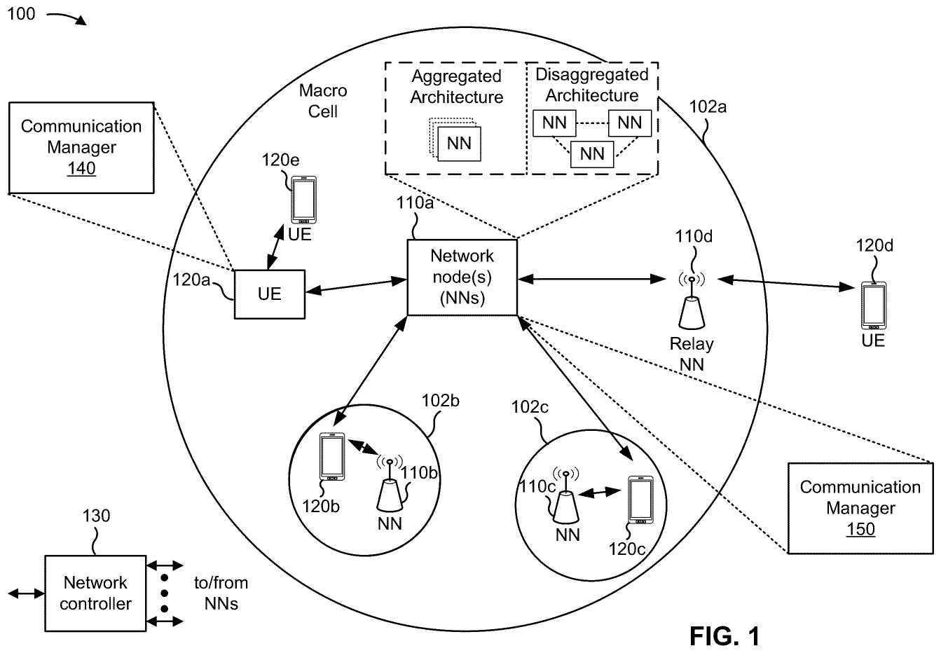

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive an indication of an NES conditional handover condition (e.g., an NES conditional handover threshold); and monitor one or more received signals based at least in part on the NES conditional handover threshold. Additionally, or alternatively, the communication manager 140 may perform one or more other operations described herein.

In some aspects, a network node (e.g., a network node 110) may include a communication manager 150. As described in more detail elsewhere herein, the communication manager 150 may transmit an indication of an NES conditional handover condition (e.g., an NES conditional handover threshold). Additionally, or alternatively, the communication manager 150 may perform one or more other operations described herein.

As indicated above, FIG. 1 is provided as an example. Other examples may differ from what is described with regard to FIG. 1.

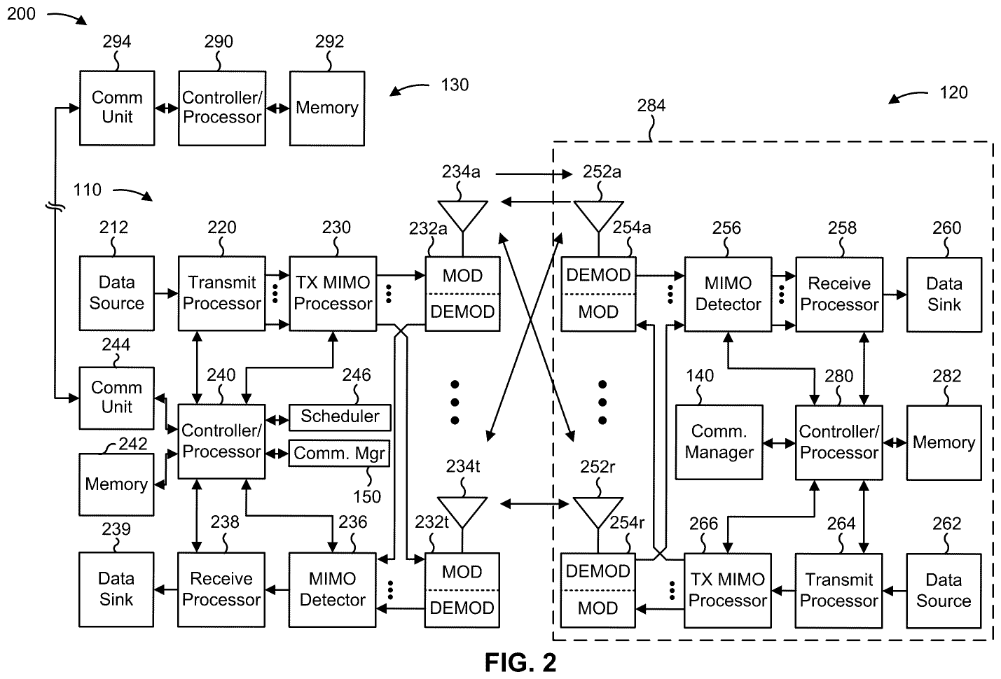

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

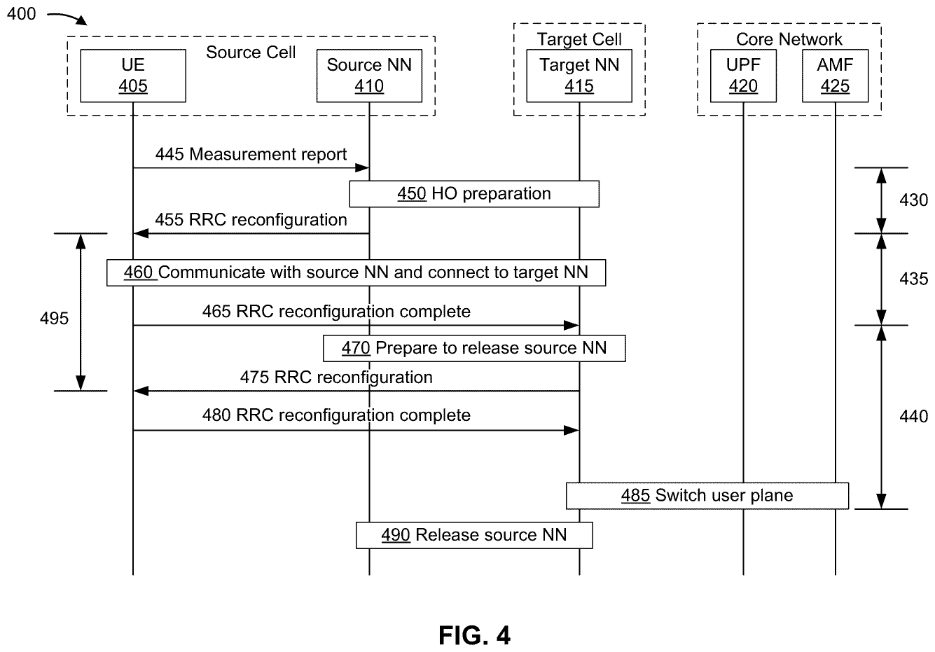

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

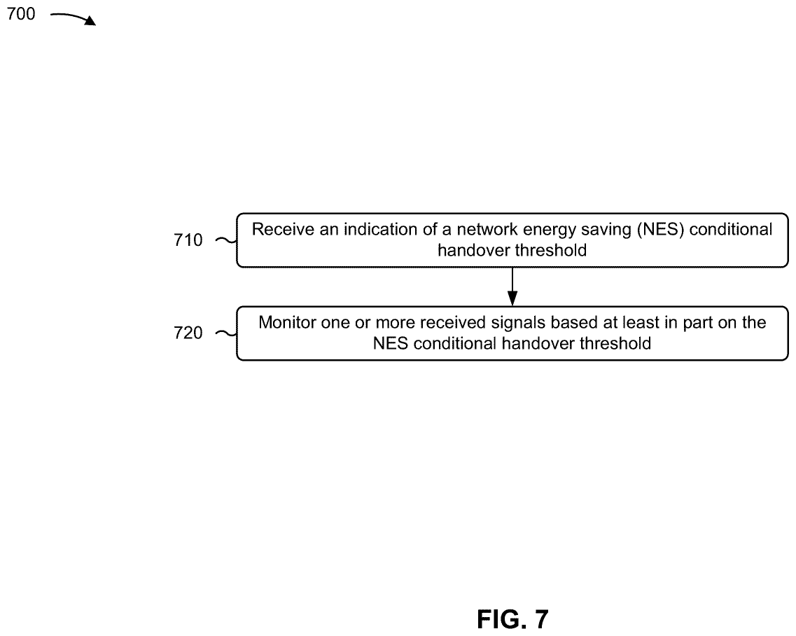

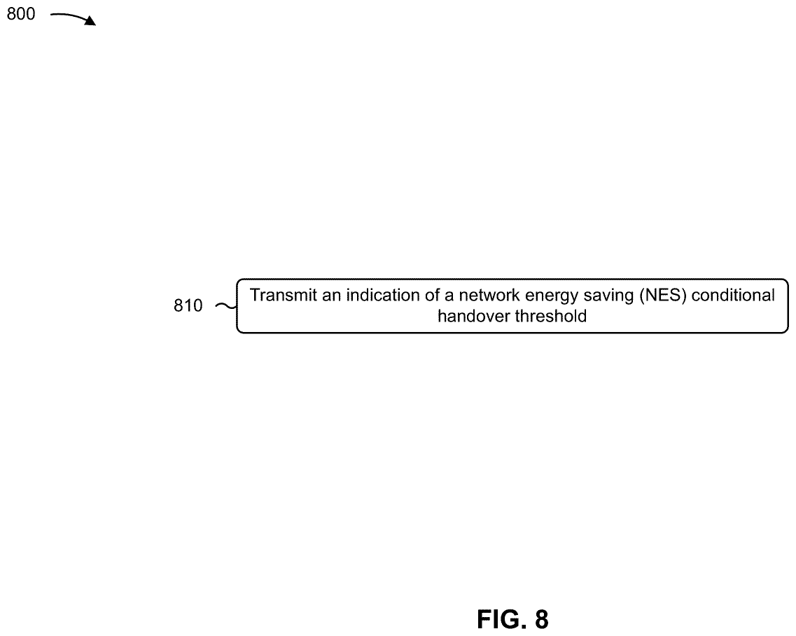

The controller/processor 240 of the network node 110, the controller/processor 280 of the UE 120, and/or any other component(s) of FIG. 2 may perform one or more techniques associated with conditional handovers based on a network energy saving mode, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving an indication of an NES conditional handover condition (e.g., an NES conditional handover threshold); and/or means for monitoring one or more received signals based at least in part on the NES conditional handover threshold. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., a network node 110) includes means for transmitting an indication of an NES conditional handover condition (e.g., an NES conditional handover threshold). The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

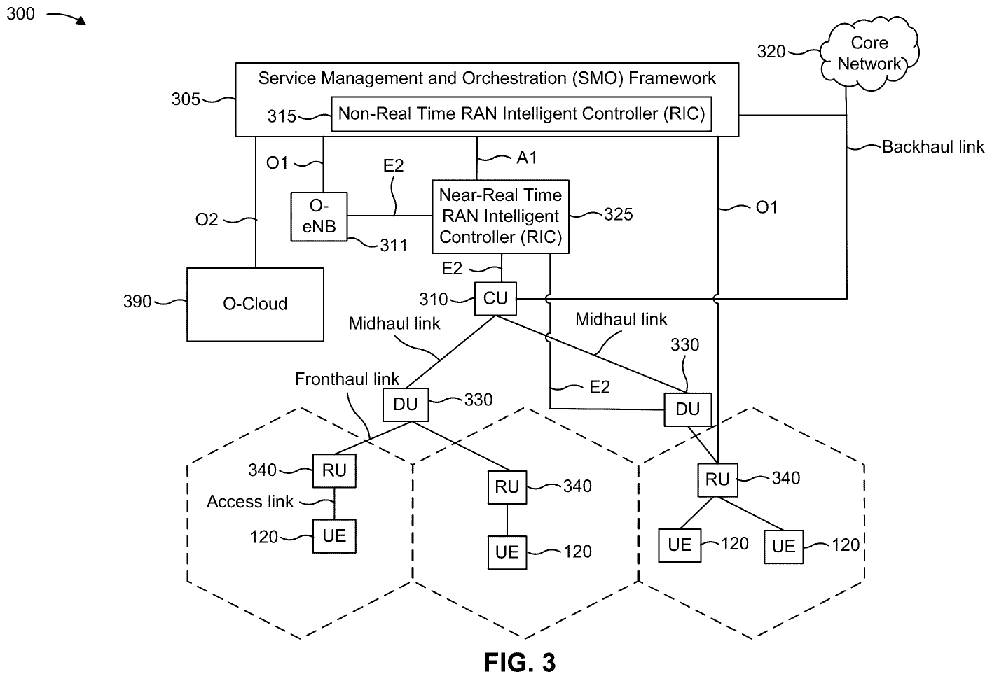

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of make-before-break handover, in accordance with the present disclosure.

As shown in FIG. 4, a make-before-break (MBB) handover procedure may involve a UE 405, a source network node 410, a target network node 415, a user plane function (UPF) device 420, and an access and mobility management function (AMF) device 425. In some examples, actions described as being performed by a network node may be performed by multiple different network nodes. For example, configuration actions and/or core network communication actions may be performed by a first network node (e.g., a CU or a DU), and radio communication actions may be performed by a second network node (e.g., a DU or an RU). The UE 405 may correspond to the UE 120 described elsewhere herein. The source network node 410 and/or the target network node 415 may correspond to the network node 110 described elsewhere herein. The UPF device 420 and/or the AMF device 425 may correspond to the network controller 130 described elsewhere herein. The UE 405 and the source network node 410 may be connected (e.g., may have an RRC connection) via a serving cell or a source cell, and the UE 405 may undergo a handover to the target network node 415 via a target cell. The UPF device 420 and/or the AMF device 425 may be located within a core network. The source network node 410 and the target network node 415 may be in communication with the core network for mobility support and user plane functions. The MBB handover procedure may include an enhanced MBB (eMBB) handover procedure.

As shown, the MBB handover procedure may include a handover preparation phase 430, a handover execution phase 435, and a handover completion phase 440. During the handover preparation phase 430, the UE 405 may report measurements that cause the source network node 410 and/or the target network node 415 to prepare for handover and trigger execution of the handover. During the handover execution phase 435, the UE 405 may execute the handover by performing a random access procedure with the target network node 415 and establishing an RRC connection with the target network node 415. During the handover completion phase 440, the source network node 410 may forward stored communications associated with the UE 405 to the target network node 415, and the UE 405 may be released from a connection with the source network node 410.

As shown by reference number 445, the UE 405 may perform one or more measurements, and may transmit a measurement report to the source network node 410 based at least in part on performing the one or more measurements (e.g., serving cell measurements and/or neighbor cell measurements). The measurement report may indicate, for example, a reference signal received power (RSRP) parameter, a reference signal received quality (RSRQ) parameter, a received signal strength indicator (RSSI) parameter, and/or a signal-to-interference-plus-noise-ratio (SINR) parameter (e.g., for the serving cell and/or one or more neighbor cells). The source network node 410 may use the measurement report to determine whether to trigger a handover to the target network node 415. For example, if one or more measurements satisfy a condition, then the source network node 410 may trigger a handover of the UE 405 to the target network node 415. In some aspects, the UE 405 may perform the measurements and/or generate the measurement report based at least in part on receiving a measurement configuration from the source network node 410. For example, the source network node 410 may indicate, by way of the measurement configuration, one or more parameters associated with performing the measurement(s), such as any combination of a frequency location, a time location, and/or a sub-carrier offset.

As shown by reference number 450, the source network node 410 and the target network node 415 may communicate with one another to prepare for a handover of the UE 405. As part of the handover preparation, the source network node 410 may transmit a handover request to the target network node 415 to instruct the target network node 415 to prepare for the handover. The source network node 410 may communicate RRC context information associated with the UE 405 and/or configuration information associated with the UE 405 to the target network node 415. The target network node 415 may prepare for the handover by reserving resources for the UE 405. After reserving the resources, the target network node 415 may transmit an acknowledgement (ACK) to the source network node 410 in response to the handover request.

As shown by reference number 455, the source network node 410 may transmit an RRC reconfiguration message to the UE 405. The RRC reconfiguration message may include a handover command instructing the UE 405 to execute a handover procedure from the source network node 410 to the target network node 415. The handover command may include information associated with the target network node 415, such as a random access channel (RACH) preamble assignment for accessing the target network node 415. Reception of the RRC reconfiguration message, including the handover command, by the UE 405 may trigger the start of the handover execution phase 435.

As shown by reference number 460, during the handover execution phase 435 of the MBB handover, the UE 405 may execute the handover by performing a random access procedure with the target network node 415 (e.g., including synchronization with the target network node 415) while continuing to communicate with the source network node 410. For example, while the UE 405 is performing the random access procedure with the target network node 415, the UE 405 may transmit uplink data, uplink control information, and/or an uplink reference signal (e.g., a sounding reference signal) to the source network node 410, and/or may receive downlink data, downlink control information, and/or a downlink reference signal from the source network node 410.

As shown by reference number 465, upon successfully establishing a connection with the target network node 415 (e.g., via a random access procedure), the UE may transmit an RRC reconfiguration completion message to the target network node 415. Reception of the RRC reconfiguration message by the target network node 415 may trigger the start of the handover completion phase 440.

As shown by reference number 470, the source network node 410 and the target network node 415 may communicate with one another to prepare for release of the connection between the source network node 410 and the UE 405. In some aspects, the target network node 415 may determine that a connection between the source network node 410 and the UE 405 is to be released, such as after receiving the RRC reconfiguration message from the UE 405. In this case, the target network node 415 may transmit a handover connection setup completion message to the source network node 410. The handover connection setup completion message may cause the source network node 410 to stop transmitting data to the UE 405 and/or to stop receiving data from the UE 405. Additionally, or alternatively, the handover connection setup completion message may cause the source network node 410 to forward communications associated with the UE 405 to the target network node 415 and/or to notify the target network node 415 of a status of one or more communications with the UE 405. For example, the source network node 410 may forward, to the target network node 415, buffered downlink communications (e.g., downlink data) for the UE 405 and/or uplink communications (e.g., uplink data) received from the UE 405. Additionally, or alternatively, the source network node 410 may notify the target network node 415 regarding a packet data convergence protocol (PDCP) status associated with the UE 405 and/or a sequence number to be used for a downlink communication with the UE 405.

As shown by reference number 475, the target network node 415 may transmit an RRC reconfiguration message to the UE 405 to instruct the UE 405 to release the connection with the source network node 410. Upon receiving the instruction to release the connection with the source network node 410, the UE 405 may stop communicating with the source network node 410. For example, the UE 405 may refrain from transmitting uplink communications to the source network node 410 and/or may refrain from monitoring for downlink communications from the source network node 410.

As shown by reference number 480, the UE may transmit an RRC reconfiguration completion message to the target network node 415 to indicate that the connection between the source network node 410 and the UE 405 is being released or has been released.

As shown by reference number 485, the target network node 415, the UPF device 420, and/or the AMF device 425 may communicate to switch a user plane path of the UE 405 from the source network node 410 to the target network node 415. Prior to switching the user plane path, downlink communications for the UE 405 may be routed through the core network to the source network node 410. After the user plane path is switched, downlink communications for the UE 405 may be routed through the core network to the target network node 415. Upon completing the switch of the user plane path, the AMF device 425 may transmit an end marker message to the source network node 410 to signal completion of the user plane path switch. As shown by reference number 490, the target network node 415 and the source network node 410 may communicate to release the source network node 410.

As part of the MBB handover procedure, the UE 405 may maintain simultaneous connections with the source network node 410 and the target network node 415 during a time period 495. The time period 495 may start at the beginning of the handover execution phase 435 (e.g., upon reception by the UE 405 of a handover command from the source network node 410) when the UE 405 performs a random access procedure with the target network node 415. The time period 495 may end upon release of the connection between the UE 405 and the source network node 410 (e.g., upon reception by the UE 405 of an instruction, from the target network node 415, to release the source network node 410). By maintaining simultaneous connections with the source network node 410 and the target network node 415, the handover procedure can be performed with zero or a minimal interruption to communications, thereby reducing latency.

In some aspects, the UE 405 may perform a conditional handover that is based at least in part on the UE 405 detecting that a conditional handover condition has been satisfied. To illustrate, the source network node 410 may indicate one or more conditional handover conditions that may trigger the UE 405 to initiate a conditional handover. A first example of a conditional handover condition is an A3 threshold that indicates that a first signal level (e.g., an RSRP metric) associated with a first signal received from a neighbor network node is better than a second signal level associated with a second signal received from a source network node by an offset (e.g., a signal level offset). A second example of a conditional handover condition is an A5 threshold that indicates that the first signal level associated with the neighbor network node has become greater than a first signal metric threshold and that the second signal level associated with the source network node has fallen below a second threshold. In some aspects, the source network node 410 may indicate the conditional handover condition(s) in RRC signaling, such as RRC signaling that is associated with transmitting the RRC reconfiguration message, as described with regard to reference number 455. Based at least in part on detecting that the A3 threshold and/or the first example of the conditional handover condition has been satisfied, the UE 405 may trigger a conditional handover to the target network node 415. Alternatively, or additionally, the UE 405 may trigger a conditional handover to the target network node 415 based at least in part on determining that the A5 threshold and/or the second example of the conditional handover condition has been satisfied. Accordingly, the source network node may indicate conditional handover condition(s), and the UE 405 may initiate a conditional handover based at least in part on determining that the conditional handover condition(s) have been satisfied.

A network node transitioning into an NES mode may introduce one or more inefficiencies in a handover procedure. To illustrate, a network node (e.g., the source network node 410 and/or the target network node 415) may transition into an NES mode during an off-peak time window (e.g., a time span when a load and/or traffic supported by the network node satisfies a reduced traffic threshold), during a maintenance procedure, and/or based at least in part on an instruction from a core network. As part of transitioning to the NES mode, the network node may offload attached UEs to another network node. For instance, the network node may transmit a respective RRC reconfiguration message to each UE that instructs the UE to perform a handover. However, the transmission of multiple RRC reconfiguration messages may delay the network node from transitioning into the NES mode and/or delay the UE performing the handover. For example, the network node may refrain from transmitting the RRC reconfiguration message to a respective UE until after the network node obtains a measurement report from the respective UE. In some aspects, signaling an RRC reconfiguration message to each UE may increase an energy consumption by the network node. Accordingly, transitioning to the NES mode may be costly in terms of energy consumption based at least in part on a number of RRC reconfiguration messages transmitted by the network node and/or costly in terms of time based at least in part on the delay incurred by both the network node and the UE. Alternatively, or additionally, the network node may transition out of a discontinuous transmission (DTX) mode and/or a discontinuous reception (DRX) mode to acquire enough air interface resources to transmit the multiple RRC reconfiguration messages, which may also increase energy consumption by the network node. Each UE may respond to the RRC reconfiguration message with an RRC reconfiguration complete message, resulting in increased energy consumption at the UE and a reduced battery life at the UE.

In some aspects, a target network node may notify the source network node that the target network node is transitioning to the NES mode, such as through a backhaul link. Based at least in part on receiving information that indicates the target network node is transitioning to the NES mode, the source network node may change one or more conditional handover conditions that are associated with the target network node to mitigate a UE triggering a conditional handover to the target network node. For example, the source network node may change an offset and/or threshold (e.g., an A3 threshold and/or an A5 threshold) to a value that may prevent the UE from triggering a conditional handover. However, in a similar manner as described above, the source network node may update the offset and/or threshold based at least in part on transmitting a respective RRC reconfiguration message to each UE, and increase energy consumption by the source network node. Alternatively, or additionally, each UE may respond to the RRC reconfiguration message with an RRC reconfiguration complete message, thus increasing energy consumption at the UE and reducing a battery life of the UE.

Some techniques and apparatuses described herein provide conditional handovers based on an NES mode. In some aspects, a UE may receive an indication of an NES conditional handover condition, such as an NES conditional handover threshold. As described below, an NES conditional handover threshold may be associated with a conditional handover trigger event (e.g., a conditional handover condition being satisfied) that is associated with a network node (e.g., a source network node and/or a target network node) operating in an NES mode. Based at least in part on receiving the indication of the NES conditional handover threshold, the UE may monitor and/or evaluate one or more received signals based at least in part on the NES conditional handover threshold. As one example, the UE may detect a conditional handover trigger event based at least in part on the NES conditional handover threshold and/or the UE may perform a conditional handover to a target network node. As another example, the UE may not detect the occurrence of the conditional handover trigger event (e.g., that is based at least in part on the NES conditional handover threshold), and, subsequently, may refrain from performing the conditional handover to the target network node.

In some aspects, a network node may transmit an indication of an NES conditional handover condition, such as an NES conditional handover threshold. As one example, the network node may transmit the indication of the NES conditional handover using a different mechanism than RRC signaling, such as RRC signaling that is associated with transmitting an RRC reconfiguration message. To illustrate, the network node may transmit the indication of the NES conditional handover in Layer 1 (L1) signaling and/or Layer 2 (L2) signaling. As another example, the indication of the NES conditional handover may indicate selection of a specific NES conditional handover threshold from multiple NES conditional handover thresholds and/or a specific conditional handover configuration from multiple conditional handover configurations, as described below. In some aspects, a conditional handover configuration may specify any combination of a conditional handover condition (e.g., a trigger event), a conditional handover criterion (e.g., a cell selection criterion for a conditional handover), and/or a conditional handover threshold.

The use of an NES conditional handover threshold may enable a source network node to offload attached UEs without transmitting respective RRC signaling to each UE that instructs the UE to perform a handover. For instance, using L1 signaling, L2 signaling, and/or a system information block (SIB) as described below, the source network node may transmit a first NES conditional handover threshold that increases a conditional handover threshold that is associated with the source network node, and results in a UE triggering a conditional handover to a target network node. Accordingly, the source network node may offload attached UEs using reduced RRC signaling and/or with less delay relative to the RRC signaling described with regard to the example 400. Reducing RRC signaling may enable a source network node to reduce energy consumption and/or transition to an NES mode more quickly. Alternatively, or additionally, transitioning to the NES mode more quickly may enable the source network node to reduce a coverage area provided by the source network node more quickly and reduce energy consumption by the source network node. In some aspects, the reduced RRC signaling may enable the UE to perform a faster handover that reduces a disruption to service at the UE and/or may mitigate the UE replying with a complementary RRC signaling (e.g., an RRC reconfiguration complete message). Reduced RRC signaling by the UE may reduce energy consumption by the UE, and preserve a battery life of the UE.

Signaling the NES conditional handover threshold via a different mechanism than RRC signaling may enable the source network node to indicate a second NES conditional handover threshold that increases a conditional handover threshold associated with the target network node, and mitigate the UE triggering a conditional threshold to the target network node. That is, the source network node may indicate the NES conditional handover threshold using reduced RRC signaling relative to the RRC signaling described with regard to example 400, reduce energy consumption by the UE, and/or preserve a battery life of the UE. Alternatively, or additionally, the NES conditional handover threshold may enable the UE to avoid selecting a network node that is operating in NES mode for a handover if another network node is available.

As indicated above, FIG. 4 is provided as an example. Other examples may differ from what is described with respect to FIG. 4.

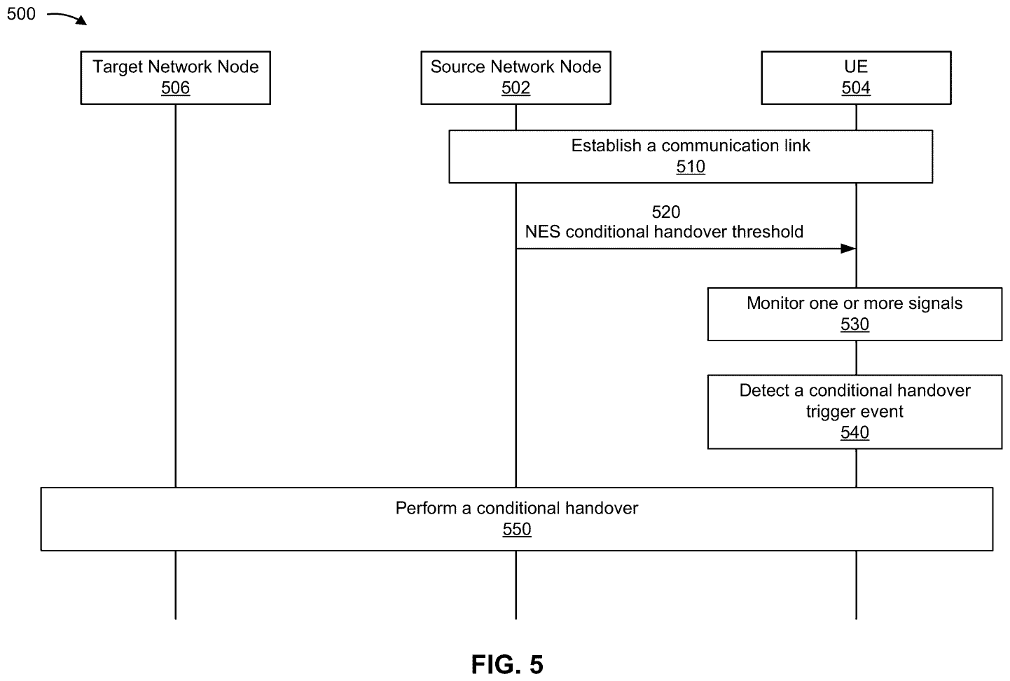

FIG. 5 is a diagram illustrating an example 500 of a wireless communication process between a source network node 502 (e.g., a network node 110), a UE 504 (e.g., a UE 120), and a target network node 506 (e.g., another node 110), in accordance with the present disclosure.

As shown by reference number 510, the source network node 502 and the UE 504 may establish a communication link between one another. As part of establishing the communication link and/or based at least in part on establishing the communication link, the source network node 502 may transmit information to the UE 504 and/or the UE 504 may transmit information to the source network node 502. As one example, the UE 504 may indicate support for an NES conditional handover procedure (e.g., the use and/or dynamic configuration of an NES conditional handover threshold). To illustrate, the UE 504 may indicate support for the NES conditional handover procedure in UE capability information. Alternatively, or additionally, the UE 504 may indicate support for the NES conditional handover procedure in a message (e.g., an L1 message, an L2 message and/or a Layer 3 (L3) message) that is transmitted separately from UE capability information. An NES conditional handover procedure may include the UE 504 receiving an indication of an NES conditional handover threshold and/or monitoring received signals based at least in part on using the NES conditional handover threshold as described below.

A baseline conditional handover threshold may be associated with a conditional handover condition (e.g., an A3 threshold and/or an A5 threshold) that is based at least in part on a network node operating in an active mode and/or a non-NES mode. The baseline conditional handover threshold may also be referred to as a non-NES conditional handover threshold. In some aspects, an NES conditional handover threshold may be associated with the same conditional handover condition (e.g., the A3 threshold and/or the A5 threshold), and may be based at least in part on the same network node operating in an NES mode. For example, and as described below, the NES conditional handover threshold may be an offset that is applied to the baseline conditional handover threshold and/or a current conditional handover threshold based at least in part on an associated network node operating in an NES mode. Having different configurations and/or modes for a conditional handover condition, such as a baseline conditional handover threshold for a first operating mode and an NES conditional handover threshold for a second operating mode, may enable a network node to modify a bound of the conditional handover condition as an operating mode of a source network node and/or a target network node changes. To illustrate, with regard to an A5 threshold, the network node may increase a first signal level threshold associated with a target network node, based at least in part on the target network node transitioning to an NES mode and decreasing a second signal level associated with the source network node. Increasing the first signal level threshold associated with the target network node may mitigate a UE performing a conditional handover to the target network node. Alternatively, or additionally and with regard to the A5 threshold, the network node may decrease the first signal level threshold associated with the target network node and increase the second signal level associated with the source network node based at least in part on the source network node transitioning to the NES mode. Increasing the second signal level threshold associated with the source network node may result in the UE performing a conditional handover from the source network node to the target network node. Accordingly, an NES conditional handover threshold may be a conditional handover threshold and/or a conditional handover condition that is associated with a network node operating in an NES mode.

Based at least in part on establishing the communication link with the UE 504, the source network node 502 may transmit an indication of multiple conditional handover configurations and/or NES conditional handover condition (e.g., NES conditional handover thresholds) for future selection. That is, the source network node 502 may indicate multiple options of conditional handover configurations and/or NES conditional handover thresholds after establishing the communication link with the UE 504 and, as described with regard to reference number 520, may indicate a selection of one of the multiple options. By transmitting the multiple options prior to selection of a particular option, the source network node 502 may indicate a selection of an option (e.g., a particular conditional handover configuration and/or a particular NES conditional handover threshold) based at least in part on using a communication mechanism (e.g., an L1 message and/or an L2 message) that is faster than RRC signaling.

As one example of indicating multiple options, the source network node 502 may transmit one or more tables using RRC signaling (e.g., one or more RRC configured tables), and the table(s) may include multiple conditional handover configurations. Each conditional handover configuration may be associated with any combination of a conditional handover condition (e.g., a trigger event), a conditional handover criterion (e.g., a cell selection criterion for a conditional handover), and/or a conditional handover threshold. A conditional handover threshold (e.g., an NES conditional handover threshold and/or a baseline conditional handover threshold) may be based at least in part on an offset that is associated with any combination of a timing threshold, a power level threshold, a signal level threshold, and/or a quality threshold. As one example, the source network node 502 may transmit, as at least part of the table(s), one or more non-NES mode conditional handover condition configurations that are associated with a network node (e.g., a source network node and/or a target network node) operating in a non-NES mode. Alternatively, or additionally, the source network node 502 may transmit, as at least part of the table(s), one or more source network node NES conditional handover condition configurations that are associated with a source network node operating in an NES mode. In some aspects, the source network node 502 may transmit, as at least part of the table(s), one or more target network node NES conditional handover condition configurations that are associated with one or more target network nodes operating in an NES mode. As described with regard to reference number 520, the source network node may indicate a selection of a conditional handover configuration (e.g., from the multiple conditional handover configurations) as at least part of indicating an NES conditional handover threshold.

As another example of indicating multiple options, the source network node 502 may transmit one or more conditional handover configurations, one or more NES conditional handover thresholds, and/or one or more cell selection criteria in a system information block (SIB). To illustrate, the network node 502 may transmit a SIB1, a SIB2, and/or a SIB4 that indicate the cell selection criteria. Some non-limiting examples of a cell selection criterion may include a signal strength criterion (e.g., a signal strength threshold, an RSRP threshold, and/or being labeled as Srxlev), a signal quality criterion (e.g., a signal quality threshold, an RSRQ threshold, and/or being labeled as Squal), and/or an offset criterion (e.g., an offset temporarily applied in evaluating a cell and/or labeled as Qoffsetₜₑₘₚ). A cell selection criterion indicated by a SIB may be associated with an RRC idle state and/or an RRC inactive state, and the source network node 502 may indicate (e.g., implicitly or explicitly) to reuse the cell selection criterion associated with the RRC idle state as an NES cell selection criterion. Alternatively, or additionally, the cell selection criteria in the SIB may explicitly indicate an NES cell selection criterion (e.g., an offset and/or an NES conditional handover threshold). To illustrate, the SIB may include a cell selection criterion that is associated with evaluating a conditional handover to a target cell operating in an NES mode (e.g., Q_{CHO-NES-offset}). That is, Q_{CHO-NES-offset} may be applied (e.g., by a UE) to one or more active and/or configured conditional handover conditions and/or evaluations. A cell selection criterion may alternatively or additionally be a cell reselection criterion. In some aspects, an NES conditional handover threshold may be associated with and/or based at least in part on a cell selection criterion. For instance, a first NES conditional handover threshold may be associated with a first cell selection criterion and a second NES conditional handover threshold may be associated with a second cell selection criterion.

Alternatively, or additionally, the source network node 502 may transmit an NES SIB (e.g., a SIB that includes an NES information element (IE) and/or has a SIB format that is associated with indicating an NES conditional handover condition, such as NES conditional handover threshold information) that may indicate multiple options for future selection. However, in other examples, the source network node 502 may transmit a SIB (e.g., a SIB1, a SIB2, a SIB4, and/or an NES SIB) to indicate the NES conditional handover threshold, as described below with regard to reference number 520. To illustrate, the NES SIB may include any combination of DTX information (e.g., an on duration, an on start time, an off duration, an off start time, and/or a duty cycle) associated with a network node (e.g., a target network node and/or a source network node), DRX information (e.g., an on duration, an on start time, an off duration, an off start time, and/or a duty cycle) associated with the network node, a cell selection offset (and/or a cell reselection offset) associated with the network node, and/or an NES conditional handover threshold associated with the network node. The NES SIB May include DTX information, DRX information, a cell selection offset, and/or a NES conditional handover threshold that may be used universally and/or applied to a group and/or all network nodes, or the NES SIB may include DTX information, DRX information, a cell selection offset, and/or a NES conditional handover threshold that is specific to a particular network node. Accordingly, a SIB (e.g., the NES SIB) may indicate any combination of serving network node NES information (e.g., DTX information, DRX information, a cell selection offset, and/or an NES conditional handover threshold), such as server network node NES information that is associated with the source network node 502, target network node NES information, and/or universal network node NES information. As described above, NES network node information may include NES conditional handover threshold information and/or delta conditional handover threshold information. To illustrate, the NES network node information (e.g., for a source network node and/or a target network node) may include any combination of a first offset that is associated with evaluating multiple and/or all conditional handover conditions, a second offset that is associated with an A3 threshold, a third offset that is associated with an A4 threshold, and/or a fourth offset that is associated with an A5 threshold.

In some aspects, the serving network node NES information may indicate multiple configurations for a single conditional handover condition that is associated with a serving network node. To illustrate, a first configuration for an A3 threshold may be associated with the serving network node (e.g., the source network node 502) operating in a normal and/or non-NES mode, and a second configuration for the A3 threshold may be associated with the serving network node operating in an NES-mode. Accordingly, the serving network node NES information may indicate, as the multiple configurations, multiple offset values for a conditional handover condition. Alternatively, or additionally, the serving network node NES information may include multiple configurations for multiple conditional handover conditions, such as a first set of configurations (e.g., a first configuration for a first operating mode of a network node and a second configuration for a second operating mode of the network node) for a first conditional handover condition, a second set of configurations for a second conditional handover condition, and/or a third set of configurations for a third conditional handover condition. In a similar manner as the source network node NES information, the target network node NES information may indicate multiple configurations for a single conditional handover condition that is associated with the target network node (e.g., the target network node 506) and/or multiple configurations for multiple conditional handover conditions. In some aspects, the target network node NES information may indicate multiple conditional handover conditions and/or multiple configurations for different target network nodes, such as one or more configurations for a first NES conditional handover condition (e.g., a first A3 threshold) that is associated with a first target network node, and one or more configurations for a second NES conditional handover condition (e.g., a second A3 threshold) that is associated with a second target network node. The source network node 502 may selectively include target network node NES information based at least in part on which target network nodes support transitioning to an NES mode. That is, the source network node 502 may only include target network node NES information for target network nodes that are capable of transitioning to the NES mode.

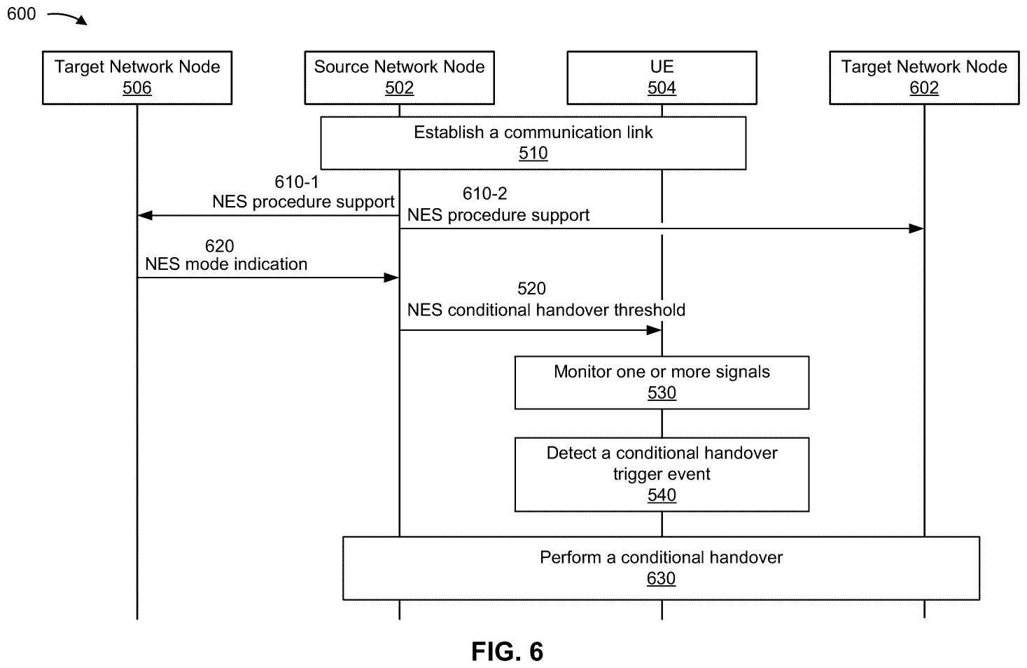

As shown by reference number 520, the source network node 502 may transmit, and the UE 504 may receive, an indication of an NES conditional handover condition (e.g., an NES conditional handover threshold). In some aspects, the source network node 502 may transmit the indication of the NES conditional handover threshold based at least in part on the UE 504 indicating the support for the NES conditional handover procedure. The source network node 502 may transmit the indication of the NES conditional handover threshold based at least in part on determining to transition into an NES mode. As another example, and as described with regard to FIG. 6, the source network node 502 may transmit the indication of the NES conditional handover threshold based at least in part on receiving a message from a target network node that indicates that the target network node is transitioning into the NES mode. Accordingly, the source network node 502 may indicate to switch a configuration for a conditional handover condition to an NES configuration (e.g., an NES conditional handover threshold). Alternatively, or additionally, the source network node 502 may transmit an instruction (e.g., explicitly or implicitly) to start evaluating a network node (e.g., the source network node 502 and/or the target network node 506) based at least in part on the NES conditional handover. To illustrate, the transmission of the indication of the NES conditional handover threshold may implicitly indicate the instruction to start evaluating the network node using the NES conditional handover threshold. Alternatively, or additionally, the source network node 502 may transmit L1 signaling and/or L2 signaling (e.g., a broadcast message, a groupcast message, and/or a unicast message) that is explicitly associated with indicating the instruction to start evaluating the network node using the NES conditional handover threshold as described below.

In some aspects, the indication transmitted by the source network node 502 may indicate a selection of an NES conditional handover threshold (e.g., from multiple options indicated by the source network node 502) as described with regard to reference number 510. Alternatively, or additionally, the indication transmitted by the source network node 502 may include and/or indicate the NES conditional handover threshold and/or NES conditional handover information. That is, in some aspects, the source network node 502 may not transmit the multiple options as described with regard to reference number 510, and, instead, may transmit the NES conditional handover threshold. The source network node 502 may transmit the indication in a broadcast message, a groupcast message (e.g., a multicast message), and/or a unicast message. To illustrate, the source network node 502 may transmit the indication in an L1 and/or L2 groupcast message that is directed to UEs that include support for an NES conditional handover procedure. Alternatively, or additionally, the source network node 502 may refrain from transmitting the indication to UEs that do not support the NES conditional handover procedure.

In some aspects, an NES conditional handover threshold may be based at least in part on an offset (e.g., a difference and or delta from a baseline), such as a first offset associated with a power level (e.g., an SINR threshold), a second offset associated with a signal level (e.g., an RSRP threshold), a third offset associated with a quality level (e.g., an RSRQ threshold), and/or a fourth offset associated with a time span (e.g., a timeToTrigger threshold associated with a conditional handover condition). To illustrate, the source network node 502 may indicate a baseline conditional handover threshold that is associated with a conditional handover condition for a network node (e.g., the source network node 502 and/or the target network node 506) that is operating in an active mode and/or a non-NES mode. Alternatively, or additionally, the source network node 502 may indicate an NES conditional handover threshold (e.g., an offset) and/or a delta conditional handover threshold, that may be used by the UE 504 to configure and/or evaluate a conditional handover condition. By transmitting an offset, the source network node 502 may implicitly indicate to generate a modified conditional handover threshold by applying (e.g., adding and/or subtracting) the offset to the baseline conditional handover threshold and/or a current conditional handover threshold being used by the UE 504. The source network node 502 may also indicate, by transmitting the offset, to use the modified conditional handover threshold for evaluating a candidate cell (e.g., for a conditional handover) and/or for identifying a measurement report trigger event (e.g., a measurement report trigger event associated with reporting the measurement report as described with regard to reference number 445 of FIG. 4). In other aspects, the source network node 502 may indicate an absolute value for the NES conditional handover threshold. The NES conditional handover threshold may be based at least in part on a power level criterion (e.g., a threshold), a signal level criterion, a quality level criterion, and/or a time criterion.

In some aspects, the source network node 502 may indicate a network node specific NES conditional handover threshold. To illustrate, the source network node 502 may indicate, as the NES conditional handover threshold, an NES source network node offset (e.g., a source network node NES conditional handover threshold) to apply (e.g., add or subtract) to a non-NES source network node conditional threshold condition. Alternatively, or additionally, the source network node 502 may indicate, as the NES conditional handover threshold, an NES target network node offset (e.g., a target network node NES conditional handover threshold) to apply to a non-NES target network node conditional threshold condition. In some aspects, the source network node 502 may indicate multiple NES conditional handover thresholds, and each NES conditional handover threshold may be associated with a respective cell selection criterion. For instance, a first NES conditional handover threshold may be associated with a first cell selection criterion and a second NES conditional handover threshold may be associated with a second cell selection criterion. Accordingly, the source network node 502 may indicate multiple NES conditional handover thresholds, and each NES conditional handover threshold may be associated with a respective network node and/or a respective cell selection criterion.

In some aspects, the source network node 502 may indicate the NES conditional handover threshold based at least in part on transmitting an indication of a selection from multiple options (e.g., multiple conditional handover configurations and/or multiple NES conditional handover thresholds). As one example, the source network node 502 may transmit an indication of an index that maps to an entry of a table, such as an RRC configured table, as described with regard to reference number 510. Alternatively, or additionally, the source network node 502 may indicate, as the NES conditional handover threshold, selection of a first configuration in serving network node NES information and/or a second configuration in target network node NES information indicated in an NES SIB. Transmitting an indication of a selection from multiple options may reduce an amount of air interface resources used by the source network node 502 to indicate the NES conditional handover threshold based at least in part on the index using fewer data bits. Using fewer data bits may enable the source network node 502 to quickly indicate the NES conditional handover threshold, and using fewer air interface resources may enable the source network node 502 to allocate more air interface resources to other purposes.

The source network node 502 may transmit the indication of the NES conditional handover threshold using a different mechanism than RRC signaling. To illustrate, the source network node 502 may indicate the NES conditional handover threshold using a different mechanism than RRC signaling associated with an RRC reconfiguration message as described with regard to reference number 455 of FIG. 5. As one example, the source network node 502 may transmit the indication of the NES conditional handover threshold as a broadcast message in L1 signaling (e.g., downlink control information (DCI)) and/or L2 signaling (e.g., a MAC control element (CE)). As one example, and as described above, the source network node 502 may transmit an index that maps to an entry of a table in the L1 signaling and/or the L2 signaling. As another example, the source network node 502 may indicate a selection of at least one of the multiple conditional handover configurations indicated in an NES SIB as described with regard to reference number 510. Alternatively, or additionally, the source network node 502 may transmit the indication to indicate the NES conditional handover threshold in a SIB, such as a SIB1, SIB2, SIB3, SIB4, and/or an NES SIB as described above.

In some aspects, the UE 504 may recover the SIB and, subsequently, the indication of the NES conditional handover threshold, based at least in part on detecting a SIB acquisition trigger event. That is, the UE 504 may refrain from recovering at least some transmissions of the SIB based at least in part on not detecting the SIB acquisition trigger event. Some non-limiting examples of a SIB acquisition trigger event may include expiration of a periodic timer, reception of a SIB update indication, and/or detection that a source network node signal level fails to satisfy a quality threshold. To illustrate, the UE 504 may configure a periodic timer internally, and autonomously obtain the SIB based at least in part on expiration of the timer. As another example, the UE 504 may autonomously obtain the SIB based at least in part on the source network node's signal level failing to satisfy the quality threshold. Alternatively, or additionally, the UE 504 may receive a SIB update indication from the source network node 502 in an L1 broadcast message and/or an L1 groupcast message, and obtain the SIB based at least in part on receiving the SIB update indication. Accordingly, the UE 504 may recover the indication of the NES conditional handover threshold from the SIB.

Alternatively, or additionally, the UE 504 may recover the SIB based at least in part on an operating state of the UE 504. As one example, the UE 504 may determine that the current operating state includes both an RRC connected state and the UE 504 operating at a cell edge. In some aspects, the UE 504 may use one or more RRC configured parameters to determine that the current operating state includes operating at the cell edge, such as a CellEdgeEvaluation-r16 criterion that is included in an information element (IE). Based at least in part on the current operating state satisfying the RRC connected state and operation at the cell edge, the UE 504 may recover the SIB and, subsequently, the NES conditional handover threshold. By recovering the SIB based at least in part on being in an RRC connected state, a UE operating in an RRC idle state and/or RRC inactive state may avoid unnecessary signaling and/or updating. Alternatively, or additionally, by recovering the SIB based at least in part on operating at the cell edge and, subsequently avoiding recovering the SIB based at least in part on not operating at the cell edge, a UE operating in a cell coverage area that may not change when the network node transitions to the NES mode may avoid unnecessary signaling and/or updating.

As shown by reference number 530, the UE 504 may monitor one or more signals based at least in part on the indication of the NES conditional handover threshold. In some aspects, the UE 504 may begin monitoring the signal(s) using the NES conditional handover threshold based at least in part on receiving an instruction to start evaluating a network node (e.g., the source network node 502 and/or the target network node 506) using the NES conditional handover threshold (e.g., as an offset and/or as an absolute value). To illustrate, the UE 504 may receive the instruction in L1 signaling and/or L2 signaling, either in a same transmission as the NES conditional handover threshold and/or in a separate transmission. Alternatively, or additionally, the UE 504 may receive the instruction as a broadcast message, a groupcast and/or multicast message, and/or a unicast message. To illustrate, the source network node 502 may transmit the indication to start evaluating the signal(s) using the NES conditional handover threshold in an L1 and/or L2 groupcast message that is directed to UEs that include support for an NES conditional handover procedure. Alternatively, or additionally, the source network node 502 may refrain from transmitting the indication to UEs that do not support the NES conditional handover procedure.

In some aspects, the UE 504 may apply (e.g., add or subtract) an NES conditional handover threshold (e.g., the offset) and/or the delta conditional handover threshold to a baseline conditional handover threshold and/or a current conditional handover threshold, and the updated value may be used by the UE 504 to evaluate a conditional handover associated with a network node (e.g., the source network node 502 and/or the target network node 506) that is operating in an NES mode. Alternatively, or additionally, the NES conditional handover threshold may be an absolute value that the UE 504 uses (e.g., without combining with another value) to evaluate the network node operating in the NES mode.

The source network node 502 may indicate, either in the same signaling and/or different signaling as the indication of the NES conditional handover threshold, a first instruction to start evaluating a conditional handover condition based at least in part on the NES conditional handover threshold and/or a second instruction to cease evaluating the conditional handover based at least in part on the NES conditional handover threshold. As one example, the source network node 502 may use L2 signaling (e.g., a MAC CE) to indicate the NES conditional handover threshold. In some aspects, the MAC CE may indicate and/or include one or more of any combination of a network node identifier, an operating mode associated with the identified network node (e.g., a first bit flag that indicates that an NES mode is enabled or disabled), an offset associated with a conditional handover condition, a conditional handover condition, and/or an operating mode associated with the conditional handover condition (e.g., a second bit flag that indicates to start evaluating the conditional handover condition and/or to cease evaluating the conditional handover condition).

In some aspects, the UE 504 may evaluate a conditional handover to a network node based at least in part on a non-NES conditional handover threshold that is associated with the network node (e.g., the same network node) operating in a different mode than the NES mode, such as an active mode, a peak-time operating mode, a full functionality operating mode, and/or a baseline operating mode. Accordingly, different conditional handover thresholds may be associated with a network node, and each conditional handover threshold may be associated with a respective operating mode of the network node. In some aspects, the operating mode may be obscured from UE 504. That is, in some aspects, the UE 504 may be instructed to update a conditional handover threshold (e.g., based at least in part on an offset and/or an absolute value) based at least in part on an NES conditional handover threshold and/or a non-NES conditional handover threshold without receiving information that indicates the operating mode of the network node. In some aspects, the UE 504 may maintain separate, different conditional handover thresholds that have an association with a respective operating mode of a network node, and monitor the one or more signals based at least in part on the different conditional handover thresholds.

In some aspects, the UE 504 may cease monitoring the signal(s) based at least in part on the NES conditional handover threshold. To illustrate, the UE 504 may receive a cease indication that specifies to cease evaluating a conditional handover condition that is based at least in part on the NES conditional handover threshold. The cease indication may specify the conditional handover condition and/or a network node associated with the conditional handover condition. For instance, the cease indication may specify to cease evaluating a first conditional handover condition that is based at least in part on a first NES conditional handover condition and/or is associated with the source network node 502. Alternatively, or additionally, the cease indication may specify to cease evaluating a second conditional handover condition that is based at least in part on a second NES conditional handover condition and/or is associated with the target network node 506. The UE 504 may receive the cease indication in any combination of L1 signaling, L2 signaling, a broadcast message, a groupcast message, a multicast message, and/or a unicast message. In some aspects, the UE 504 may receive (e.g., via the L1 signaling, L2 signaling, a broadcast message, a groupcast message, a multicast message, and/or a unicast message) an instruction to remove a particular conditional handover threshold, such as an NES conditional handover threshold associated with a particular target network node, from memory and/or a cell monitoring list. To illustrate, the instruction to remove the conditional handover threshold may be associated with a target network node that is scheduled (or has) powered down. Accordingly, the UE 504 may remove the conditional handover threshold from the list and/or cease to monitor a signal associated with a network node using the conditional handover threshold.

As shown by reference number 540, the UE 504 may detect a conditional handover trigger event. That is, the UE 504 may detect that a conditional handover condition that is based at least in part on the NES conditional handover has been satisfied (e.g., a first conditional handover condition associated with an A3 threshold has been satisfied and/or a second conditional handover associated with an A5 threshold has been satisfied).

As shown by reference number 550, the UE 504, the source network node 502, and the target network node 506 may perform a handover (e.g., a conditional handover). In performing the handover, the UE 504 may dismantle and/or tear down the communication link with the source network node 502 and/or establish a second communication link with the target network node 506.

The use of an NES conditional handover condition (e.g., an NES conditional handover threshold) may enable a source network node to offload attached UEs without transmitting a respective RRC signaling that instructs each UE to perform a handover. For instance, the source network node may transmit a first NES conditional handover threshold that increases a conditional handover threshold that is associated with the source network node, and results in a UE triggering a conditional handover to a target network node. Accordingly, the source network node may offload attached UEs without transmitting respective RRC signaling to each UE, and reduce an amount of RRC signaling performed by the source network node and the respective UEs. Reducing an amount of RRC signaling may enable a source network node to reduce energy consumption and/or transition to an NES mode more quickly. Alternatively, or additionally, reducing an amount of RRC signaling by the source network node may also reduce an amount of RRC signaling performed by each UE, reduce energy consumption by the UE, preserve a battery life of the UE, enable the UE to perform the handover more quickly, and/or reduce a disruption to service at the UE.

As indicated above, FIG. 5 is provided as an example. Other examples may differ from what is described with regard to FIG. 5.

FIG. 6 is a diagram illustrating an example 600 of a wireless communication process between the source network node 502, the UE 504, and the target network node 506 as described with regard to FIG. 5, and a second target network node 602 (e.g., another network node 110), in accordance with the present disclosure.

As described with regard to FIG. 5, and as shown by reference number 510, the source network node 502 and the UE 504 may establish a communication link between one another. As part of establishing the communication link and/or based at least in part on establishing the communication link, the source network node 502 may transmit information to the UE 504, and/or the UE 504 may transmit information to the source network node 502. To illustrate, the source network node 502 may transmit and/or indicate multiple options of NES conditional handover thresholds and/or conditional handover configurations. Alternatively, or additionally, the source network node 502 may transmit and/or indicate one or more non-NES conditional handover thresholds and/or conditional handover configurations. In some aspects, the UE 504 may indicate support for an NES conditional handover procedure, such as in UE capability information and/or a message that is in a different transmission than the UE capability information.

As shown by reference number 610-1, the source network node 502 may transmit, and the target network node 506 may receive, an indication that the UE 504 supports the NES conditional handover procedure. Alternatively, or additionally, as shown by reference number 610-2, the source network node 502 may transmit, and the second target network node 602 may receive, an indication that the UE 504 supports the NES conditional handover procedure. To illustrate, the source network node 502 may communicate the indication that the UE 504 supports the NES conditional handover procedure using a backhaul link to the target network node 506 and/or the second target network node 602. In some aspects, the indication that the UE 504 supports the NES conditional handover procedure may obscure an identity of the UE 504. For example, the source network node 502 may transmit an indication that a UE that supports the NES conditional handover procedure (e.g., the UE 504) is attached to the source network node 502. While FIG. 6 shows the source network node 502 transmitting the indication to a target network node (e.g., the target network node 506 and/or the second target network node 602), other examples may include different network nodes of a disaggregated base station transmitting and/or receiving the indication that the UE 504 supports the NES conditional handover procedure. As one example, a CU of a disaggregated base station as described with regard to FIG. 3 may transmit the indication to a DU of the disaggregated base station.

As shown by reference number 620, the target network node 506 may transmit, and the source network node may receive, an indication that the target network node 506 has transitioned, or will transition, to an NES mode. For example, the target network node 506 may transmit the indication of the NES mode operation via the backhaul link. Alternatively, or additionally, the target network node 506 may transmit the indication of the NES mode operation based at least in part on receiving the indication that the UE 504 supports the NES conditional handover procedure and/or that a UE attached to the source network node 502 supports the NES conditional handover procedure. In some aspects, the target network node 506 may indicate a start time associated with the transition to the NES mode. While FIG. 6 shows the target network node 506 transmitting the indication of transitioning to the NES mode to the source network node 502, other examples may include different network nodes of a disaggregated base station transmitting and/or receiving the indication of transitioning to the NES mode. As one example, a DU of a disaggregated base station as described with regard to FIG. 3 may transmit the indication to a CU of the disaggregated base station.

As shown by reference number 520, the source network node 502 may transmit, and the UE 504 may receive, an indication of an NES conditional handover condition (e.g., an NES conditional handover threshold) as described with regard to FIG. 5. In some aspects, the source network node 502 may transmit the indication of the NES conditional handover threshold based at least in part on receiving the indication and/or message from the target network node 506 as described with regard to reference number 620 (e.g., the target network node is transitioning into the NES mode and/or is operating in the NES mode).

The source network node 502 may transmit the indication of the NES conditional handover threshold using L1 signaling and/or L2 signaling. Alternatively, or additionally, the source network node 502 may transmit the indication of the NES conditional handover threshold in a SIB. The NES conditional handover threshold may be network node specific (e.g., specific to the target network node 506). Accordingly, the source network node 502 may indicate a network node identifier and/or associate the network node identifier with the NES conditional handover threshold. In some aspects, the source network node 502 may indicate the NES conditional handover threshold based at least in part on transmitting an indication of a selection from multiple options (e.g., multiple conditional handover configurations and/or multiple NES conditional handover thresholds). The source network node 502 may broadcast the indication, may transmit the indication in a groupcast and/or multicast message, and/or may transmit the indication in a unicast message, such as by transmitting a groupcast message to UEs that support an NES conditional handover procedure.

In some aspects, the UE 504 may receive and/or recover a SIB that indicates the NES conditional handover threshold based at least in part on detecting a SIB acquisition trigger event. Alternatively, or additionally, the UE 504 may receive and/or recover the SIB based at least in part on an operating state of the UE 504, such as a SIB recovery condition that is associated with a current operating state of the UE 504 including both an RRC connected state and the UE 504 operating at a cell edge.

As shown by reference number 530, the UE 504 may monitor one or more signals based at least in part on the indication of the NES conditional handover threshold as described with regard to FIG. 5. In some aspects, the UE 504 may begin monitoring the signal(s) using the NES conditional handover threshold based at least in part on receiving an instruction to start evaluating a network node (e.g., the source network node 502 and/or the target network node 506) based at least in part on the NES conditional handover threshold and/or a conditional threshold condition that is associated with the NES conditional handover threshold. As one example, the UE 504 may receive the instruction in a MAC CE, as described above.

In some aspects, the UE 504 may cease monitoring the signal(s) based at least in part on the NES conditional handover threshold. To illustrate, the UE 504 may receive a cease indication that specifies to cease evaluating a conditional handover condition that is based at least in part on the NES conditional handover threshold. For instance, the UE 504 may receive a MAC CE that specifies a network node, a conditional handover condition associated with the network node, and/or an operating mode (e.g., start evaluating and/or stop evaluating). The UE 504 may receive the cease indication in any combination of L1 signaling, L2 signaling, a broadcast message, a groupcast message, a multicast message, and/or a unicast message.

In some aspects, the UE 504 may receive an instruction to remove a particular conditional handover threshold (e.g., an NES conditional handover threshold and/or a non-NES conditional handover threshold) from memory and/or a cell monitoring list. Accordingly, the UE 504 may remove the particular conditional handover threshold from the list and/or cease using the particular conditional handover threshold to monitor a signal associated with a network node.

As shown by reference number 540, the UE 504 may detect a conditional handover trigger event. That is, the UE 504 may detect that a conditional handover condition that is based at least in part on the NES conditional handover has been satisfied.

As shown by reference number 630, the UE 504, the source network node 502, and the second target network node 602 may perform a handover (e.g., a conditional handover). In performing the handover, the UE 504 may dismantle and/or tear down the communication link with the source network node 502 and/or establish a second communication link with the second target network node 602.

The use of an NES conditional handover threshold may enable a source network node to mitigate a UE triggering a conditional threshold to a target network node that is operating in an NES mode. In some aspects, the source network node may transmit the indication of the NES conditional handover threshold using a different mechanism than RRC signaling. Mitigating the UE attempting to perform a handover to a target network node that is operating in the NES mode may reduce an amount of RRC signaling between the UE and the source network node, as well as the UE and the target network node operating in the NES mode. Reducing an amount of RRC signaling may reduce energy consumption by the UE, preserve a battery life of the UE, enable the UE to perform the handover more quickly, and/or reduce a disruption to service at the UE.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with conditional handovers based on a network energy saving mode.

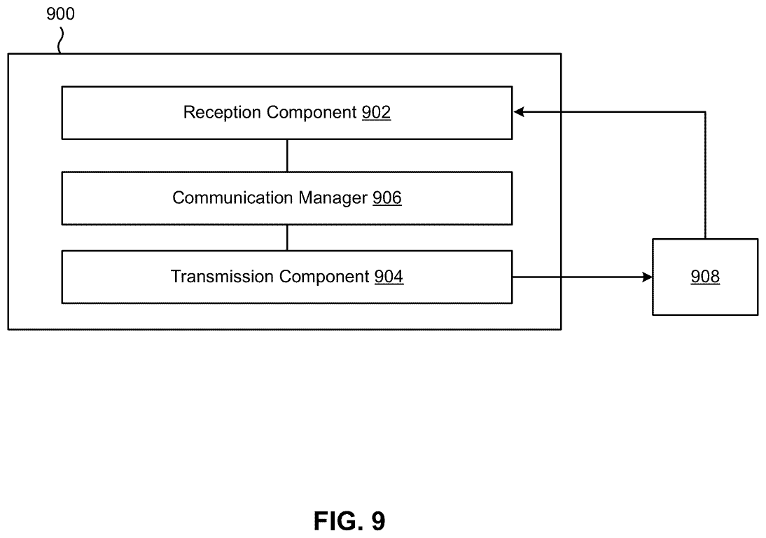

As shown in FIG. 7, in some aspects, process 700 may include receiving an indication of an NES conditional handover threshold (block 710). For example, the UE (e.g., using reception component 902 and/or communication manager 906, depicted in FIG. 9) may receive an indication of an NES conditional handover threshold, as described above.

As further shown in FIG. 7, in some aspects, process 700 may include monitoring one or more received signals based at least in part on the NES conditional handover threshold (block 720). For example, the UE (e.g., using communication manager 906, depicted in FIG. 9) may monitor one or more received signals based at least in part on the NES conditional handover threshold, as described above.

Process 700 may include additional aspects, such as any single aspect or any combination of aspects described below and/or in connection with one or more other processes described elsewhere herein.

In a first aspect, process 700 includes detecting a conditional handover trigger event based at least in part on the NES conditional handover threshold, and performing a conditional handover to a target network node.

In a second aspect, receiving the indication of the NES conditional handover threshold includes receiving the indication using a different mechanism than RRC signaling.

In a third aspect, the different mechanism is different from an RRC reconfiguration message.

In a fourth aspect, the NES conditional handover threshold includes a delta conditional handover threshold.

In a fifth aspect, the NES conditional handover threshold includes an NES conditional handover offset that is associated with a conditional handover power level threshold.

In a sixth aspect, receiving the indication of the NES conditional handover threshold includes receiving the indication in a SIB.

In a seventh aspect, the SIB is an NES SIB, the NES conditional handover threshold is a first NES conditional handover threshold, and the NES SIB indicates at least one of DTX information associated with a target network node, DRX information associated with the target network node, a cell selection offset associated with the target network node, or a second NES conditional handover threshold associated with the target network node.

In an eighth aspect, process 700 includes detecting a SIB acquisition trigger event, and receiving the indication in the SIB is based at least in part on detecting the SIB acquisition trigger event.

In a ninth aspect, the SIB acquisition trigger event includes at least one of a periodic timer or reception of a SIB update indication.

In a tenth aspect, the SIB indicates at least one of serving network node NES information, or target network node NES information.

In an eleventh aspect, the serving network node NES information indicates at least two configurations for a single conditional handover condition that is associated with a serving network node.

In a twelfth aspect, the target network node NES information indicates at least two configurations for a single conditional handover condition that is associated with the target network node.

In a thirteenth aspect, the target network node NES information indicates at least a first NES conditional handover condition associated with a first target network node, and a second NES conditional handover condition associated with a second target network node.

In a fourteenth aspect, process 700 includes receiving a SIB update indication in at least one of an L1 broadcast message, or an L1 groupcast message, and receiving the indication in the SIB is based at least in part on receiving the SIB update indication.

In a fifteenth aspect, process 700 includes indicating support for an NES conditional handover procedure, and receiving the indication of the NES conditional handover threshold is based at least part on indicating the support for the NES conditional handover procedure.

In a sixteenth aspect, indicating the support for the NES conditional handover procedure includes transmitting UE capability information that indicates the support for the NES conditional handover procedure.

In a seventeenth aspect, the NES conditional handover threshold includes a time threshold.

In an eighteenth aspect, process 700 includes receiving, in a SIB, at least one cell selection criterion that is associated with an RRC idle state, and the NES conditional handover threshold is based at least in part on the at least one cell selection criterion.

In a nineteenth aspect, receiving the indication of the NES conditional handover threshold includes receiving the indication of the NES conditional handover threshold in a SIB, and the NES conditional handover includes an offset that is associated with at least one of evaluating a candidate cell, or identifying a measurement report trigger event,

In a twentieth aspect, process 700 includes determining that a current operating state includes being in an RRC connected state and operating at a cell edge, and recovering the SIB based at least in part on the current operating state.

In a twenty-first aspect, the indication of the NES conditional handover threshold is a first indication, and process 700 includes receiving, in a SIB, a second indication to remove at least one conditional handover condition that is associated with a target network node.

In a twenty-second aspect, receiving the indication of the NES conditional handover threshold includes receiving the indication of the NES conditional handover threshold as a broadcast message in L1 signaling or L2 signaling.

In a twenty-third aspect, the indication is a first indication, and process 700 includes receiving multiple conditional handover configurations, the multiple conditional handover configurations include at least one of: one or more normal operation conditional handover condition configurations, one or more source network node NES conditional handover condition configurations, or one or more target network node NES conditional handover condition configurations, and receiving the indication of the NES conditional handover threshold includes receiving, in the broadcast message in L1 signaling or L2 signaling, selection of one of the multiple conditional handover configurations.

In a twenty-fourth aspect, receiving the multiple conditional handover configurations includes receiving the multiple conditional handover configurations in RRC signaling.

In a twenty-fifth aspect, receiving the indication of the NES conditional handover threshold includes receiving, as the NES conditional handover threshold, at least one of an NES source network node offset to apply to a non-NES source network node conditional threshold condition, or an NES target network node offset to apply to a non-NES target network node conditional threshold condition.

In a twenty-sixth aspect, process 700 includes receiving, in the L1 or the L2 signaling, an instruction to start evaluating the NES conditional handover threshold.

In a twenty-seventh aspect, the L1 signaling includes downlink control information.

In a twenty-eighth aspect, the L2 signaling includes a MAC CE.

In a twenty-ninth aspect, the indication of the NES conditional handover threshold is a first indication, and process 700 includes receiving, in a broadcast message in L1 signaling or L2 signaling, a second indication to cease evaluating at least one conditional handover condition that is associated with a target network node.

In a thirtieth aspect, the indication of the NES conditional handover threshold is a first indication, and process 700 includes receiving, as a broadcast message in L1 signaling or L2 signaling, a second indication of an NES mode of a target network node.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with conditional handovers based on a network energy saving mode.

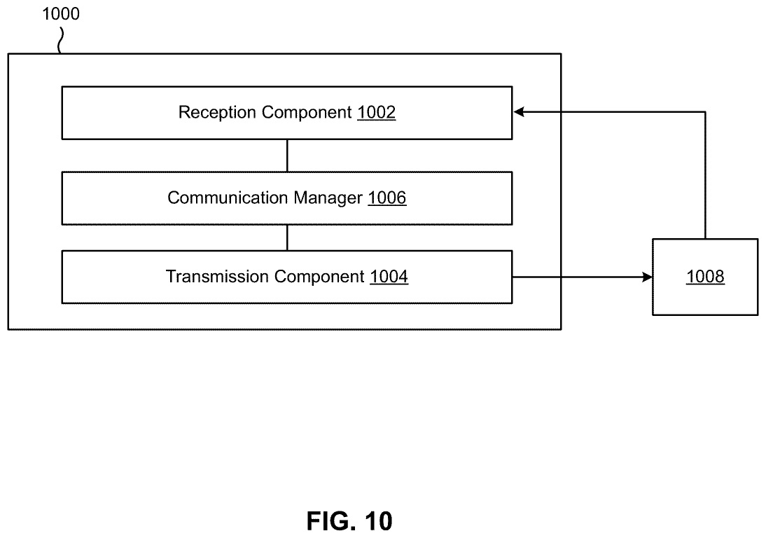

As shown in FIG. 8, in some aspects, process 800 may include transmitting an indication of an NES conditional handover threshold (block 810). For example, the network node (e.g., using transmission component 1004 and/or communication manager 1006, depicted in FIG. 10) may transmit an indication of an NES conditional handover threshold, as described above.

Process 800 may include additional aspects, such as any single aspect or any combination of aspects described below and/or in connection with one or more other processes described elsewhere herein.

In a first aspect, transmitting the indication of the NES conditional handover threshold includes transmitting the indication using a different mechanism than RRC signaling.

In a second aspect, the RRC signaling includes an RRC reconfiguration message.

In a third aspect, the NES conditional handover threshold includes a delta conditional handover threshold.

In a fourth aspect, the NES conditional handover threshold includes an NES conditional handover offset that is associated with a conditional handover power level threshold.

In a fifth aspect, transmitting the indication of the NES conditional handover threshold includes transmitting the indication in a SIB.

In a sixth aspect, the SIB is an NES SIB, the NES conditional handover threshold is a first NES conditional handover threshold, and the NES SIB indicates at least one of DTX information associated with a target network node, DRX information associated with the target network node, a cell selection offset associated with the target network node, or a second NES conditional handover threshold associated with the target network node.

In a seventh aspect, process 800 includes transmitting a SIB update indication that is associated with the NES SIB.

In an eighth aspect, transmitting the SIB update indication includes transmitting the SIB update indication in at least one of an L1 broadcast message, or an L1 groupcast message.

In a ninth aspect, the SIB indicates at least one of serving network node NES information, or target network node NES information.

In a tenth aspect, the serving network node NES information indicates at least two configurations for a single conditional handover condition that is associated with a serving network node.

In an eleventh aspect, the target network node NES information indicates at least two configurations for a single conditional handover condition that is associated with the target network node.

In a twelfth aspect, the target network node NES information indicates at least a first NES conditional handover condition associated with a first target network node, and a second NES conditional handover condition associated with a second target network node.

In a thirteenth aspect, the indication of the NES conditional handover threshold is a first indication, and process 800 includes receiving a second indication that a UE supports an NES conditional handover procedure, and transmitting the indication of the NES conditional handover threshold is based at least part on receiving the second indication that the UE supports the NES conditional handover procedure.

In a fourteenth aspect, receiving the second indication includes receiving UE capability information that includes the second indication.

In a fifteenth aspect, the network node is a first network node, and process 800 includes forwarding the second indication that the UE supports the NES conditional handover procedure to a second network node.

In a sixteenth aspect, the indication of the NES conditional handover threshold is a first indication, the network node is a first network node, process 800 includes receiving, from a second network node, a second indication that specifies that the second network node is transitioning into an NES mode, and transmitting the indication of the NES conditional handover threshold is based at least in part on receiving the second indication.

In a seventeenth aspect, the NES conditional handover threshold includes a time threshold.

In an eighteenth aspect, process 800 includes transmitting, in a SIB, at least one cell selection criterion that is associated with a UE operating in an RRC idle state, and the NES conditional handover threshold is based at least in part on the at least one cell selection criterion.

In a nineteenth aspect, transmitting the indication of the NES conditional handover threshold includes transmitting a SIB that includes the NES conditional handover threshold, and the NES conditional handover threshold includes an offset that is associated with at least one of evaluating a candidate cell, or identifying a measurement report trigger event,

In a twentieth aspect, the indication of the NES conditional handover threshold is a first indication, and process 800 includes transmitting, in a SIB, a second indication to remove at least one conditional handover condition that is associated with a target network node.

In a twenty-first aspect, transmitting the indication of the NES conditional handover threshold includes transmitting the indication of the NES conditional handover threshold as a broadcast message in L1 signaling or L2 signaling.

In a twenty-second aspect, the indication is a first indication, process 800 includes transmitting multiple conditional handover configurations that include at least two of: one or more normal operation conditional handover condition configurations, one or more source network node NES conditional handover condition configurations, or one or more target network node NES conditional handover condition configurations, and transmitting the indication of the NES conditional handover threshold includes transmitting, in the broadcast message in L1 signaling or L2 signaling, selection of one of the multiple conditional handover configurations.

In a twenty-third aspect, transmitting the multiple conditional handover configurations includes transmitting the multiple conditional handover configurations in RRC signaling.

In a twenty-fourth aspect, transmitting the indication of the NES conditional handover threshold includes transmitting, as the NES conditional handover threshold, at least one of an NES source network node offset to apply to a non-NES source network node conditional threshold condition, or an NES target network node offset to apply to a non-NES target network node conditional threshold condition.

In a twenty-fifth aspect, process 800 includes transmitting, in the L1 signaling or the L2 signaling, an instruction to start evaluating the NES conditional handover threshold.

In a twenty-sixth aspect, the L1 signaling includes downlink control information.

In a twenty-seventh aspect, the L2 signaling includes a MAC CE.

In a twenty-eighth aspect, the indication of the NES conditional handover threshold is a first indication, and process 800 includes transmitting, in a broadcast message in L1 signaling or L2 signaling, a second indication to cease evaluating at least one conditional handover condition that is associated with a target network node.

In a twenty-ninth aspect, the indication of the NES conditional handover threshold is a first indication, and process 800 includes transmitting, as a broadcast message in L1 signaling or L2 signaling, a second indication of an NES mode of a target network node.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-8. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may receive, by way of the reception component 902, an indication of an NES conditional handover threshold. The communication manager 906 may monitor one or more received signals based at least in part on the NES conditional handover threshold. In some aspects, the communication manager 906 may detect a conditional handover trigger event based at least in part on the NES conditional handover threshold. Alternatively, or additionally, the communication manager 906 may perform a conditional handover to a target network node.

The communication manager 906 may detect a SIB acquisition trigger event, and receiving the indication in the SIB is based at least in part on detecting the SIB acquisition trigger event. In some aspects, the communication manager 906 may receive, by way of the reception component 902, a SIB update indication in at least one of: an L1 broadcast message or an L1 groupcast message.

The communication manager 906 may indicate support for an NES conditional handover procedure, and receiving the indication of the NES conditional handover threshold is based at least part on indicating the support for the NES conditional handover procedure. The communication manager may receive, by way of the reception component 902 and in the L1 signaling or the L2 signaling, an instruction to start evaluating the NES conditional handover threshold.

In some aspects, the communication manager 906 may receive, by way of the reception component 902 and in a SIB, at least one cell selection criterion that is associated with an RRC idle state, and the NES conditional handover threshold is based at least in part on the at least one cell selection criterion. The communication manager 906 may determine that a current operating state includes being in an RRC connected state and operating at a cell edge. Based at least in part on the current operating state, the communication manager 906 may recover the SIB.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-8. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The communication manager 1006 may transmit, by way of the transmission component 1004, an indication of an NES conditional handover threshold. Alternatively, or additionally, the communication manager 1006 may transmit, by way of the transmission component 1004, a SIB update indication that is associated with the NES SIB. In some aspects, the communication manager 1006 may transmit, by way of the transmission component 1004 and in a SIB, at least one cell selection criterion that is associated with a UE operating in an RRC idle state, and the NES conditional handover threshold is based at least in part on the at least one cell selection criterion. The communication manager 1006 may transmit, by way of the transmission component 1004 and in the L1 signaling or the L2 signaling, an instruction to start evaluating the NES conditional handover threshold.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving an indication of a network energy saving (NES) conditional handover threshold; and monitoring one or more received signals based at least in part on the NES conditional handover threshold.

Aspect 2: The method of Aspect 1, further comprising: detecting a conditional handover trigger event based at least in part on the NES conditional handover threshold; and performing a conditional handover to a target network node.

Aspect 3: The method of any of Aspects 1-2, wherein receiving the indication of the NES conditional handover threshold comprises: receiving the indication using a different mechanism than radio resource control (RRC) signaling.

Aspect 4: The method of Aspect 3, wherein the different mechanism is different from an RRC reconfiguration message.

Aspect 5: The method of any of Aspects 1-4, wherein the NES conditional handover threshold comprises a delta conditional handover threshold.

Aspect 6: The method of any of Aspects 1-5, wherein the NES conditional handover threshold comprises an NES conditional handover offset that is associated with a conditional handover power level threshold.

Aspect 7: The method of any of Aspects 1-6, wherein receiving the indication of the NES conditional handover threshold comprises: receiving the indication in a system information block (SIB).

Aspect 8: The method of Aspect 7, wherein the SIB is an NES SIB, wherein the NES conditional handover threshold is a first NES conditional handover threshold, and wherein the NES SIB indicates at least one of: discontinuous transmission (DTX) information associated with a target network node, discontinuous reception (DRX) information associated with the target network node, a cell selection offset associated with the target network node, or a second NES conditional handover threshold associated with the target network node.

Aspect 9: The method of Aspect 7, further comprising: detecting a SIB acquisition trigger event, wherein receiving the indication in the SIB is based at least in part on detecting the SIB acquisition trigger event.

Aspect 10: The method of Aspect 9, wherein the SIB acquisition trigger event comprises at least one of: expiration of a periodic timer, reception of a SIB update indication.

Aspect 11: The method of Aspect 7, wherein the SIB indicates at least one of: serving network node NES information, or target network node NES information.

Aspect 12: The method of Aspect 11, wherein the serving network node NES information indicates at least two configurations for a single conditional handover condition that is associated with a serving network node.

Aspect 13: The method of Aspect 11, wherein the target network node NES information indicates at least two configurations for a single conditional handover condition that is associated with the target network node.

Aspect 14: The method of Aspect 11, wherein the target network node NES information indicates at least: a first NES conditional handover condition associated with a first target network node, and a second NES conditional handover condition associated with a second target network node.

Aspect 15: The method of Aspect 7, further comprising: receiving a SIB update indication in at least one of: a Layer 1 (L1) broadcast message, or an L1 groupcast message, and wherein receiving the indication in the SIB is based at least in part on receiving the SIB update indication, wherein receiving the indication in the SIB is based at least in part on receiving the SIB update indication.

Aspect 16: The method of any of Aspects 1-15, further comprising: indicating support for an NES conditional handover procedure, wherein receiving the indication of the NES conditional handover threshold is based at least part on indicating the support for the NES conditional handover procedure.

Aspect 17: The method of Aspect 16, wherein indicating the support for the NES conditional handover procedure comprises: transmitting UE capability information that indicates the support for the NES conditional handover procedure.

Aspect 18: The method of any of Aspects 1-17, wherein the NES conditional handover threshold comprises a time threshold.

Aspect 19: The method of any of Aspects 1-18, further comprising: receiving, in a system information block (SIB), at least one cell selection criterion that is associated with a radio resource control (RRC) idle state, wherein the NES conditional handover threshold is based at least in part on the at least one cell selection criterion.

Aspect 20: The method of any of Aspects 1-19, wherein receiving the indication of the NES conditional handover threshold comprises: receiving the indication of the NES conditional handover threshold in a system information block (SIB), wherein the NES conditional handover comprises an offset that is associated with at least one of: evaluating a candidate cell, or identifying a measurement report trigger event,

Aspect 21: The method of Aspect 20, further comprising: determining that a current operating state comprises being in a radio resource control (RRC) connected state and operating at a cell edge; and recovering the SIB based at least in part on the current operating state.

Aspect 22: The method of any of Aspects 1-21, wherein the indication of the NES conditional handover threshold is a first indication, and the method further comprises: receiving, in a system information block (SIB), a second indication to remove at least one conditional handover condition that is associated with a target network node.

Aspect 23: The method of any of Aspects 1-22, wherein receiving the indication of the NES conditional handover threshold comprises: receiving the indication of the NES conditional handover threshold as a broadcast message in Layer 1 signaling or Layer 2 signaling.

Aspect 24: The method of Aspect 23, wherein the indication is a first indication, and the method further comprises: receiving multiple conditional handover configurations, the multiple conditional handover configurations including at least one of: one or more normal operation conditional handover condition configurations, one or more source network node NES conditional handover condition configurations, or one or more target network node NES conditional handover condition configurations, wherein receiving the indication of the NES conditional handover threshold comprises: receiving, in the broadcast message in Layer 1 signaling or Layer 2 signaling, selection of one of the multiple conditional handover configurations.

Aspect 25: The method of Aspect 24, wherein receiving the multiple conditional handover configurations comprises: receiving the multiple conditional handover configurations in radio resource control (RRC) signaling.

Aspect 26: The method of Aspect 23, wherein receiving the indication of the NES conditional handover threshold comprises: receiving, as the NES conditional handover threshold, at least one of: an NES source network node offset to apply to a non-NES source network node conditional threshold condition, or an NES target network node offset to apply to a non-NES target network node conditional threshold condition.

Aspect 27: The method of Aspect 23, further comprising: receiving, in the L1 signaling or the Layer 2 signaling, an instruction to start evaluating the NES conditional handover threshold.

Aspect 28: The method of Aspect 23, wherein the Layer 1 signaling comprises downlink control information.

Aspect 29: The method of Aspect 23, wherein the Layer 2 signaling comprises a medium access control (MAC) control element (CE).

Aspect 30: The method of any of Aspects 1-29, wherein the indication of the NES conditional handover threshold is a first indication, and the method further comprises: receiving, in a broadcast message in Layer 1 signaling or Layer 2 signaling, a second indication to cease evaluating at least one conditional handover condition that is associated with a target network node.

Aspect 31: The method of any of Aspects 1-30, wherein the indication of the NES conditional handover threshold is a first indication, and the method further comprises: receiving, as a broadcast message in Layer 1 signaling or Layer 2 signaling, a second indication of an NES mode of a target network node.

Aspect 32: A method of wireless communication performed by a network node, comprising: transmitting an indication of a network energy saving (NES) conditional handover threshold.

Aspect 33: The method of Aspect 32, wherein transmitting the indication of the NES conditional handover threshold comprises: transmitting the indication using a different mechanism than radio resource control (RRC) signaling.

Aspect 34: The method of Aspect 33, wherein the RRC signaling comprises an RRC reconfiguration message.

Aspect 35: The method of any of Aspects 32-34, wherein the NES conditional handover threshold comprises a delta conditional handover threshold.

Aspect 36: The method of any of Aspects 32-35, wherein the NES conditional handover threshold comprises an NES conditional handover offset that is associated with a conditional handover power level threshold.

Aspect 37: The method of any of Aspects 32-36, wherein transmitting the indication of the NES conditional handover threshold comprises: transmitting the indication in a system information block (SIB).

Aspect 38: The method of Aspect 37, wherein the SIB is an NES SIB, wherein the NES conditional handover threshold is a first NES conditional handover threshold, and wherein the NES SIB indicates at least one of: discontinuous transmission (DTX) information associated with a target network node, discontinuous reception (DRX) information associated with the target network node, a cell selection offset associated with the target network node, or a second NES conditional handover threshold associated with the target network node.

Aspect 39: The method of Aspect 38, further comprising: transmitting a SIB update indication that is associated with the NES SIB.

Aspect 40: The method of Aspect 39, wherein transmitting the SIB update indication comprises: transmitting the SIB update indication in at least one of: a Layer 1 (L1) broadcast message, or an L1 groupcast message.

Aspect 41: The method of Aspect 37, wherein the SIB indicates at least one of: serving network node NES information, or target network node NES information.

Aspect 42: The method of Aspect 41, wherein the serving network node NES information indicates at least two configurations for a single conditional handover condition that is associated with a serving network node.

Aspect 43: The method of Aspect 41, wherein the target network node NES information indicates at least two configurations for a single conditional handover condition that is associated with the target network node.

Aspect 44: The method of Aspect 41, wherein the target network node NES information indicates at least: a first NES conditional handover condition associated with a first target network node, and a second NES conditional handover condition associated with a second target network node.

Aspect 45: The method of any of Aspects 32-44, wherein the indication of the NES conditional handover threshold is a first indication, and the method further comprises: receiving a second indication that a user equipment (UE) supports an NES conditional handover procedure, wherein transmitting the indication of the NES conditional handover threshold is based at least part on receiving the second indication that the UE supports the NES conditional handover procedure.

Aspect 46: The method of Aspect 45, wherein receiving the second indication comprises: receiving UE capability information that includes the second indication.

Aspect 47: The method of Aspect 45, wherein the network node is a first network node, and the method further comprises: forwarding the second indication that the UE supports the NES conditional handover procedure to a second network node.

Aspect 48: The method of any of Aspects 32-47, wherein the indication of the NES conditional handover threshold is a first indication, wherein the network node is a first network node, and the method further comprises: receiving, from a second network node, a second indication that specifies that the second network node is transitioning into an NES mode, wherein transmitting the indication of the NES conditional handover threshold is based at least in part on receiving the second indication.

Aspect 49: The method of any of Aspects 32-48, wherein the NES conditional handover threshold comprises a time threshold.

Aspect 50: The method of any of Aspects 32-49, further comprising: transmitting, in a system information block (SIB), at least one cell selection criterion that is associated with a user equipment (UE) operating in a radio resource control (RRC) idle state, wherein the NES conditional handover threshold is based at least in part on the at least one cell selection criterion.

Aspect 51: The method of any of Aspects 32-50, wherein transmitting the indication of the NES conditional handover threshold comprises transmitting a system information block (SIB) that includes the NES conditional handover threshold, wherein the NES conditional handover threshold comprises an offset that is associated with at least one of: evaluating a candidate cell, or identifying a measurement report trigger event,

Aspect 52: The method of any of Aspects 32-51, wherein the indication of the NES conditional handover threshold is a first indication, and the method further comprises: transmitting, in a system information block (SIB), a second indication to remove at least one conditional handover condition that is associated with a target network node.

Aspect 53: The method of any of Aspects 32-52, wherein transmitting the indication of the NES conditional handover threshold comprises: transmitting the indication of the NES conditional handover threshold as a broadcast message in Layer 1 signaling or Layer 2 signaling.

Aspect 54: The method of Aspect 53, wherein the indication is a first indication, and the method further comprises: transmitting multiple conditional handover configurations that include at least two of: one or more normal operation conditional handover condition configurations, one or more source network node NES conditional handover condition configurations, or one or more target network node NES conditional handover condition configurations, wherein transmitting the indication of the NES conditional handover threshold comprises: transmitting, in the broadcast message in Layer 1 signaling or Layer 2 signaling, selection of one of the multiple conditional handover configurations.

Aspect 55: The method of Aspect 54, wherein transmitting the multiple conditional handover configurations comprises: transmitting the multiple conditional handover configurations in radio resource control (RRC) signaling.

Aspect 56: The method of Aspect 53, wherein transmitting the indication of the NES conditional handover threshold comprises: transmitting, as the NES conditional handover threshold, at least one of: an NES source network node offset to apply to a non-NES source network node conditional threshold condition, or an NES target network node offset to apply to a non-NES target network node conditional threshold condition.

Aspect 57: The method of Aspect 53, further comprising: transmitting, in the Layer 1 signaling or the Layer 2 signaling, an instruction to start evaluating the NES conditional handover threshold.

Aspect 58: The method of Aspect 53, wherein the Layer 1 signaling comprises downlink control information.

Aspect 59: The method of Aspect 53, wherein the Layer 2 signaling comprises a medium access control (MAC) control element (CE).

Aspect 60: The method of any of Aspects 32-59, wherein the indication of the NES conditional handover threshold is a first indication, and the method further comprises: transmitting, in a broadcast message in Layer 1 signaling or Layer 2 signaling, a second indication to cease evaluating at least one conditional handover condition that is associated with a target network node.

Aspect 61: The method of any of Aspects 32-60, wherein the indication of the NES conditional handover threshold is a first indication, and the method further comprises: transmitting, as a broadcast message in Layer 1 signaling or Layer 2 signaling, a second indication of an NES mode of a target network node.

Aspect 62: An apparatus for wireless communication at a device, comprising a processor; memory coupled with the processor; and instructions stored in the memory and executable by the processor to cause the apparatus to perform the method of one or more of Aspects 1-61.

Aspect 63: A device for wireless communication, comprising a memory and one or more processors coupled to the memory, the one or more processors configured to perform the method of one or more of Aspects 1-61.

Aspect 64: An apparatus for wireless communication, comprising at least one means for performing the method of one or more of Aspects 1-61.

Aspect 65: A non-transitory computer-readable medium storing code for wireless communication, the code comprising instructions executable by a processor to perform the method of one or more of Aspects 1-61.

Aspect 66: A non-transitory computer-readable medium storing a set of instructions for wireless communication, the set of instructions comprising one or more instructions that, when executed by one or more processors of a device, cause the device to perform the method of one or more of Aspects 1-61.

Aspect 67: A method of wireless communication performed by a user equipment (UE), comprising: receiving an indication of a network energy saving (NES) conditional handover condition; and monitoring one or more received signals based at least in part on the NES conditional handover condition.

Aspect 68: An apparatus for wireless communication at a device, comprising a processor; memory coupled with the processor; and instructions stored in the memory and executable by the processor to cause the apparatus to perform the method of one or more of Aspect 67.

Aspect 69: A device for wireless communication, comprising a memory and one or more processors coupled to the memory, the one or more processors configured to perform the method of one or more of Aspect 67.

Aspect 70: An apparatus for wireless communication, comprising at least one means for performing the method of one or more of Aspect 67.

Aspect 71: A non-transitory computer-readable medium storing code for wireless communication, the code comprising instructions executable by a processor to perform the method of one or more of Aspect 67.

Aspect 72: A non-transitory computer-readable medium storing a set of instructions for wireless communication, the set of instructions comprising one or more instructions that, when executed by one or more processors of a device, cause the device to perform the method of one or more of Aspects 67.

Aspect 73: A method of wireless communication performed by a network node, comprising: transmitting an indication of a network energy saving (NES) conditional handover condition.

Aspect 74: An apparatus for wireless communication at a device, comprising a processor; memory coupled with the processor; and instructions stored in the memory and executable by the processor to cause the apparatus to perform the method of one or more of Aspect 73.

Aspect 75: A device for wireless communication, comprising a memory and one or more processors coupled to the memory, the one or more processors configured to perform the method of one or more of Aspect 73.

Aspect 76: An apparatus for wireless communication, comprising at least one means for performing the method of one or more of Aspect 73.

Aspect 77: A non-transitory computer-readable medium storing code for wireless communication, the code comprising instructions executable by a processor to perform the method of one or more of Aspect 73.

Aspect 78: A non-transitory computer-readable medium storing a set of instructions for wireless communication, the set of instructions comprising one or more instructions that, when executed by one or more processors of a device, cause the device to perform the method of one or more of Aspects 73.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured to cause the UE to:
receive an indication of a network energy saving (NES) conditional handover condition; and
monitor one or more received signals based at least in part on the NES conditional handover condition.

2. The apparatus of claim 1, wherein the one or more processors are further configured to cause the UE to:
detect a conditional handover trigger event based at least in part on an NES conditional handover threshold that is indicated by the NES conditional handover condition; and
perform a conditional handover to a target network node.

3. The apparatus of claim 1, wherein the one or more processors, to cause the UE to receive the indication of the NES conditional handover condition, are configured to cause the UE to:
receive the indication using a different mechanism than radio resource control (RRC) signaling.

4. The apparatus of claim 3, wherein the different mechanism is different from an RRC reconfiguration message.

5. The apparatus of claim 1, wherein the NES conditional handover condition comprises an NES conditional handover threshold that is based at least in part on an NES conditional handover offset that is associated with a conditional handover power level threshold.

6. The apparatus of claim 1, wherein the one or more processors, to cause the UE to receive the indication of the NES conditional handover condition, are configured to cause the UE to:
receive serving network node NES information that indicates at least two configurations for a single conditional handover condition that is associated with a serving network node.

7. The apparatus of claim 1, wherein the one or more processors are further configured to cause the UE to
transmit UE capability information that indicates support for an NES conditional handover procedure.

8. The apparatus of claim 1, wherein the one or more processors, to cause the UE to receive the indication of the NES conditional handover condition, are configured to cause the UE to:
receive the indication of the NES conditional handover condition in Layer 1 signaling as:
broadcast message, or
a groupcast message.

9. The apparatus of claim 8, wherein the one or more processors are further configured to cause the UE to:
receive multiple conditional handover configurations, the multiple conditional handover configurations including at least one of:
one or more normal operation conditional handover condition configurations, or
one or more source network node NES conditional handover condition configurations.

10. The apparatus of claim 9, wherein the one or more processors, to cause the UE to receive the multiple conditional handover configurations, are configured to cause the UE to:
receive the multiple conditional handover configurations in radio resource control (RRC) signaling.

11. The apparatus of claim 8, wherein the one or more processors are further configured to cause the UE to:
receive, in the Layer 1 signaling, an instruction to start evaluating an NES conditional handover threshold that is indicated by the NES conditional handover condition, and
begin using the NES conditional handover threshold to monitor one or more signals.

12. The apparatus of claim 8, wherein the one or more processors are further configured to cause the UE to downlink control information.

13. An apparatus for wireless communication at a network node, comprising:
one or more memories; and
one or more processors, coupled to the one or more memories, configured to cause the network node to:
transmit an indication of a network energy saving (NES) conditional handover condition.

14. The apparatus of claim 13, wherein the one or more processors, to cause the network node to transmit the indication of the NES conditional handover condition, are configured to cause the network node to:
transmit the indication using a different mechanism than radio resource control (RRC) signaling.

15. The apparatus of claim 14, wherein the RRC signaling comprises an RRC reconfiguration message.

16. The apparatus of claim 13, wherein the NES conditional handover condition indicates an NES conditional handover threshold that is based at least in part on an NES conditional handover offset that is associated with a conditional handover power level threshold.

17. The apparatus of claim 13, wherein the one or more processors, to cause the network node to transmit the indication of the NES conditional handover condition, are configured to cause the network node to:
transmit serving network node NES information that indicates at least two configurations for a single conditional handover condition that is associated with a serving network node.

18. The apparatus of claim 13, the indication of the NES conditional handover condition is a first indication, and
wherein the one or more processors are further configured to cause the network node to:
receive a second indication that a user equipment (UE) supports an NES conditional handover procedure,
wherein the one or more processors, to cause the network node to transmit the first indication of the NES conditional handover condition, are configured to cause the network node to:
transmit the first indication of the NES conditional handover condition based at least part on receiving the second indication that the UE supports the NES conditional handover procedure.

19. The apparatus of claim 18, wherein the one or more processors, to cause the network node to receive the second indication, are configured to cause the network node to:
receive UE capability information that includes the second indication.

20. The apparatus of claim 13, wherein the one or more processors, to cause the network node to transmit the indication of the NES conditional handover condition, are configured to cause the network node to:
transmit the indication of the NES conditional handover condition as a broadcast message in Layer 1 signaling.

21. The apparatus of claim 20, wherein the one or more processors are further configured to cause the network node to:
transmit multiple conditional handover configurations that include at least two of:
one or more normal operation conditional handover condition configurations, or
one or more source network node NES conditional handover condition configurations.

22. The apparatus of claim 21, wherein the one or more processors, to cause the network node to transmit the multiple conditional handover configurations, are configured to cause the network node to:
transmit the multiple conditional handover configurations in radio resource control (RRC) signaling.

23. The apparatus of claim 20, wherein the one or more processors are further configured to cause the network node to:
transmit, in the Layer 1 signaling, an instruction to start evaluating an NES conditional handover threshold that is indicated by the NES conditional handover condition.

24. The apparatus of claim 20, wherein the one or more processors are further configured to cause the network node to downlink control information.

25. A method of wireless communication performed by a user equipment (UE), comprising:
receiving an indication of a network energy saving (NES) conditional handover condition; and
monitoring one or more received signals based at least in part on the NES conditional handover condition.

26. The method of claim 25, further comprising:
detecting a conditional handover trigger event based at least in part on an NES conditional handover threshold that is indicated by the NES conditional handover condition; and
performing a conditional handover to a target network node.

27. The method of claim 25, wherein receiving the indication of the NES conditional handover condition comprises:
receiving the indication using a different mechanism than radio resource control (RRC) signaling.

28. A method of wireless communication performed by a network node, comprising:
transmitting an indication of a network energy saving (NES) conditional handover condition.

29. The method of claim 28, wherein transmitting the indication of the NES conditional handover condition comprises:
transmitting the indication using a different mechanism than radio resource control (RRC) signaling.

30. The method of claim 28, wherein the NES conditional handover condition comprises an NES conditional handover threshold.
